(19) United States
(12) Patent Application Publication
(10) Pub. No.: US 2025/0227572 A1
(43) Pub. Date: Jul. 10, 2025

(54) METHOD AND APPARATUS FOR BEAM FAILURE RECOVERY ON A CELL WITH SEMI PERSISTENT SYNCHRONIZATION SIGNAL IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/004,670

(22) Filed: Dec. 30, 2024

(30) Foreign Application Priority Data
Jan. 8, 2024 (KR) 1020240002737

(51) Int. Cl. H04W 36/00; H04W 36/30; H04W 72/23

(52) U.S. Cl. CPC H04W 36/0079; H04W 36/305; H04W 72/23

(57) ABSTRACT

A method and apparatus to support beam failure recovery in a system with semi-persistent synchronization signal is provided. The method includes receiving from a base station a radio resource control (RRC) message that comprises a set of configuration parameters for a secondary cell (SCell), receiving from the base station a set of bits in a downlink message, setting a beam failure indication counter of the SCell to a specific value, cancelling a beam failure recovery triggered for the SCell, stopping a layer 1 measurement reporting for the SCell and removing the SCell from a list for layer 3 measurement. The specific bit of the set of bits sets to a first value. The specific bit corresponds to the SCell.

### CROSS-REFERENCE TO RELATED APPLICATION

This application claims priority to and the benefit of Korean Patent Application No. 10-2024-0002737, filed on Jan. 8, 2024, the disclosure of which is hereby incorporated herein by reference in its entirety.

### BACKGROUND

### Technical Field

The present disclosure relates to synchronization signal transmission for network energy efficiency in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability.

In the advancement of 5G networks, one significant focus is improving network energy efficiency. A key innovation in this area is Synchronization Signal Block (SSB) transmission.

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network.

Periodic transmission of SSBs degrades network energy efficiency especially in low load/traffic scenario.

### SUMMARY

Aspects of the present disclosure are to address beam failure recovery in a system with semi-persistent synchronization signal. The method includes receiving from a base station a radio resource control (RRC) message that comprises a set of configuration parameters for a secondary cell (SCell), receiving from the base station a set of bits in a downlink message, setting a beam failure indication counter of the SCell to a specific value, cancelling a beam failure recovery triggered for the SCell, stopping a layer 1 measurement reporting for the SCell and removing the SCell from a list for layer 3 measurement. The specific bit of the set of bits sets to a first value. The specific bit corresponds to the SCell.

### BRIEF DESCRIPTION OF THE DRAWINGS

FIG. 1A is a diagram illustrating the architecture of an 5G system and a NG-RAN.

FIG. 1B is a diagram illustrating a wireless protocol architecture in an 5G system.

FIG. 2A illustrates the overall operation of the UE and network.

FIG. 2B illustrates RRC connection establishment procedure.

FIG. 2C illustrates UE capability transfer procedure.

FIG. 2D illustrates RRC connection reconfiguration procedure.

FIG. 2E illustrates data transfer procedure in RRC_CONNECTED state.

FIG. 2F illustrates SS/PBCH block.

FIG. 3A illustrates the operation of the UE and network for SIB-less secondary cell.

FIG. 3B illustrates the operation of the UE and network for assistance information transfer.

FIG. 4A is a diagram illustrating measurement operations of the terminal.

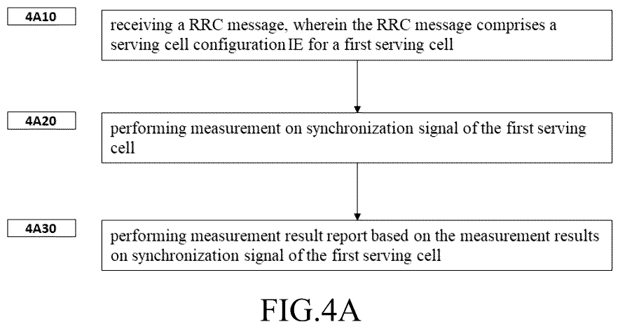

FIG. 4B is a diagram illustrating measurement reporting operations of the terminal.

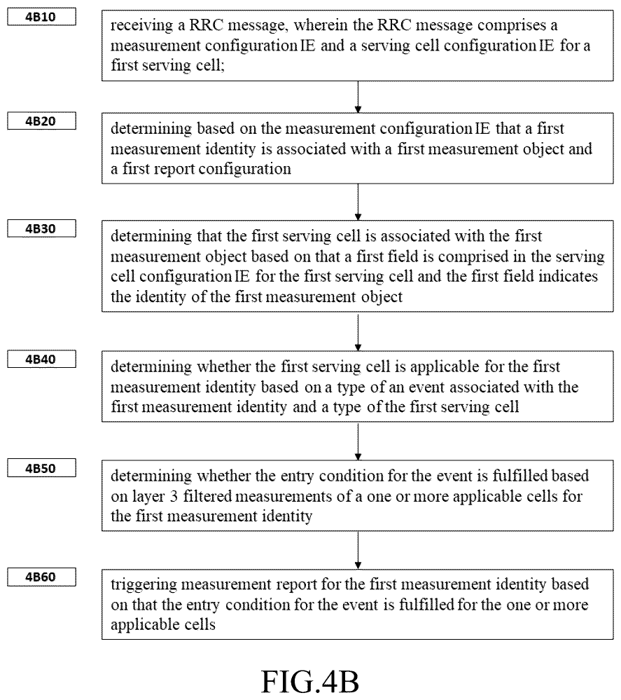

FIG. 4C is a diagram illustrating operations of the terminal for downlink control channel monitoring.

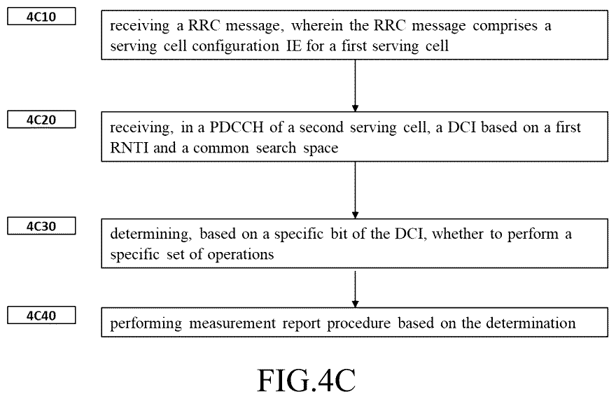

FIG. 4D is a diagram illustrating operations of the terminal for cell status change.

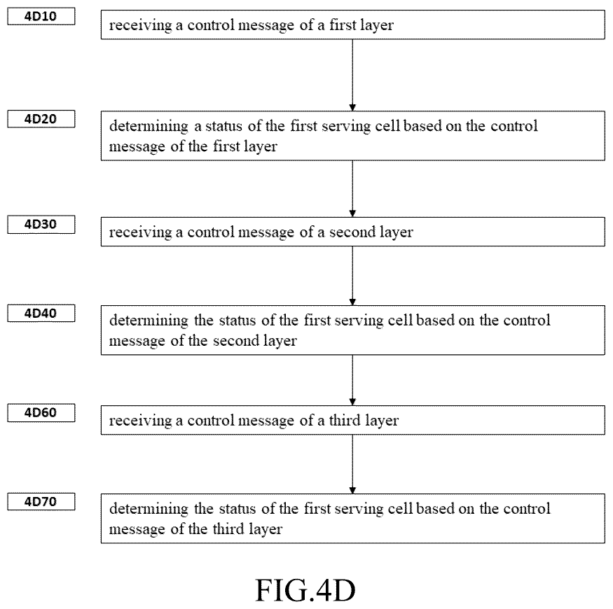

FIG. 5A is a block diagram illustrating the internal structure of a UE to which the disclosure is applied.

FIG. 5B is a block diagram illustrating the configuration of a base station according to the disclosure.

### DETAILED DESCRIPTION

SSBs are critical components in 5G NR (New Radio) that carry essential information for cell search, signal synchronization, and initial access procedures. They enable User Equipment (UE) to discover and connect to the network.

Traditionally, SSBs are broadcast periodically at fixed intervals, regardless of whether any UEs are present or attempting to access the network, which results in unnecessary network energy consumption. One solution to remedy this problem is demand-driven SSB transmission.

On-demand SSB transmission represents a significant step towards sustainable and efficient 5G networks. By aligning signal transmissions with actual demand, networks can drastically reduce energy consumption without compromising connectivity. This approach not only benefits network operators through cost savings but also supports global efforts in reducing the carbon footprint of telecommunications infrastructure. To enable demand driven SSB transmission, new hardware, signaling and protocol are required.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

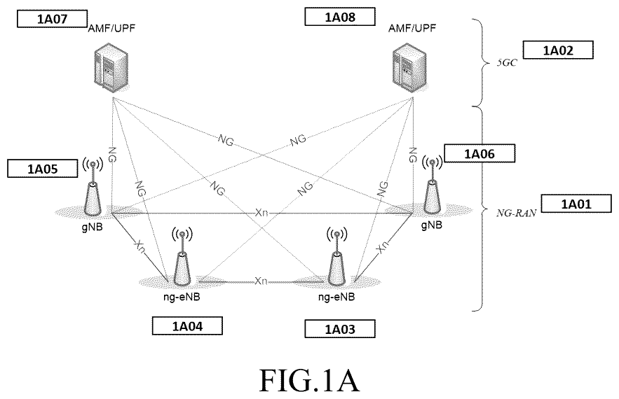

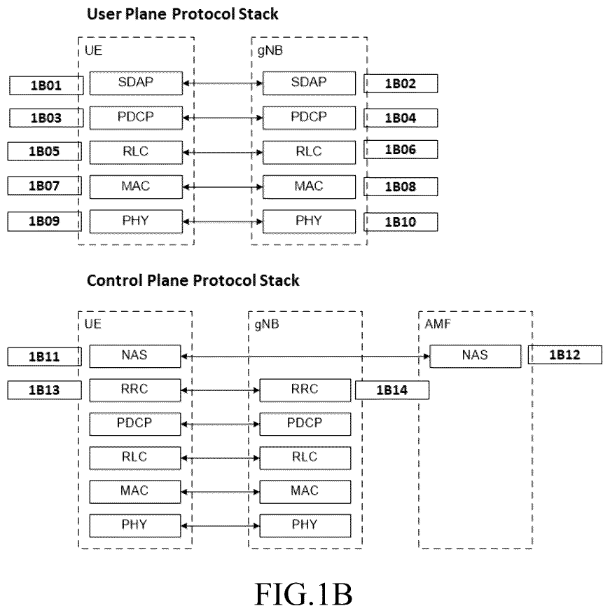

FIG. 1A is a diagram illustrating the architecture of an 5G system and a NG-RAN to which the disclosure may be applied.

5G system consists of NG-RAN 1A01 and 5GC 1A02. An NG-RAN node is either:
1: a gNB, providing NR user plane and control plane protocol terminations towards the UE; or
1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement reporting configuration for mobility and scheduling; and
1: Session Management; and
1: QoS Flow management and mapping to data radio bearers; and
1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B 11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

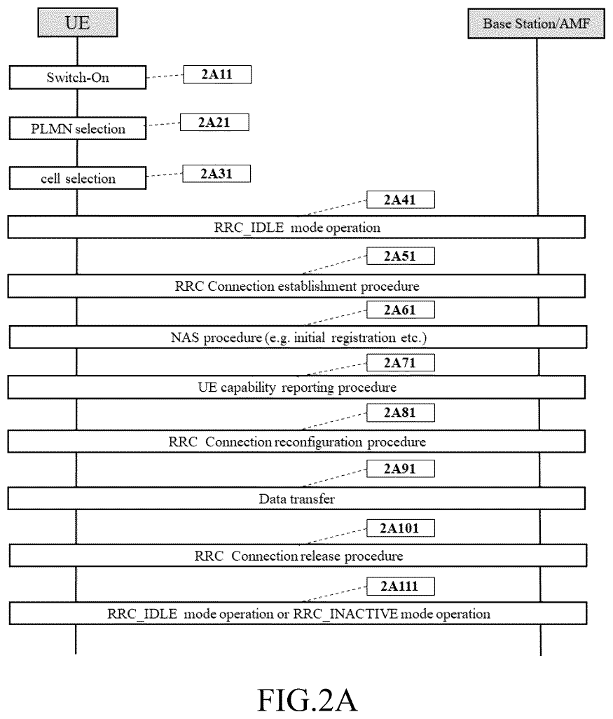

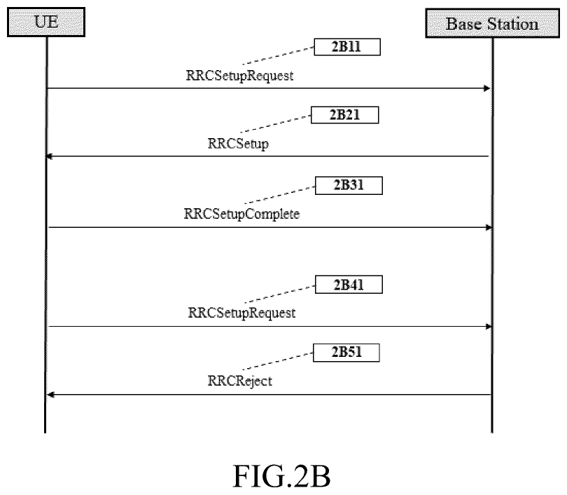

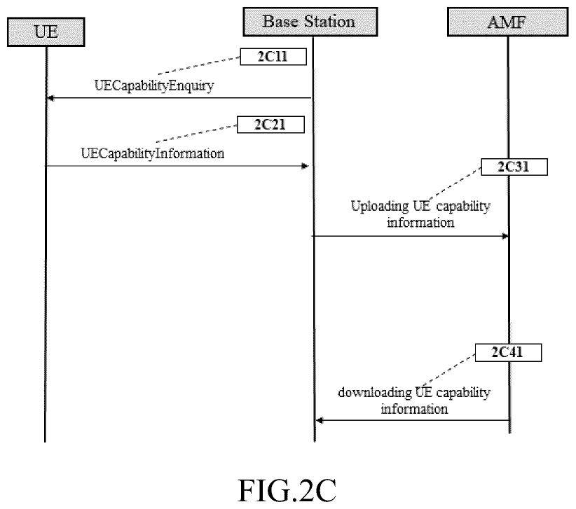

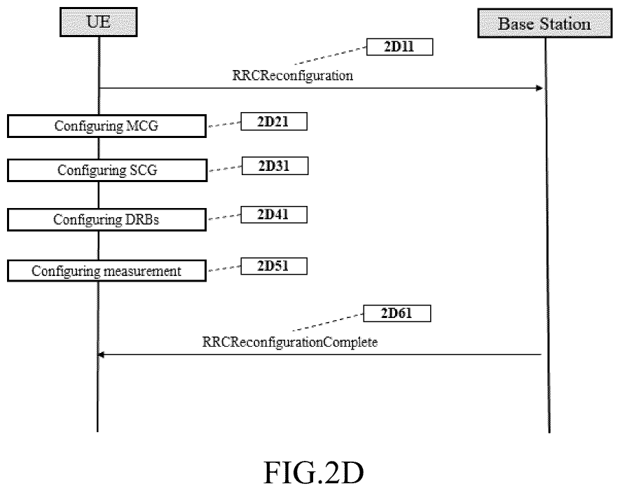

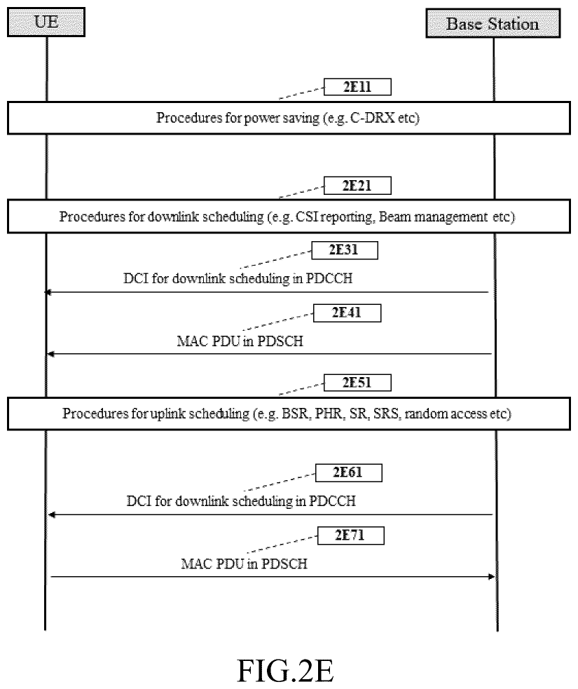

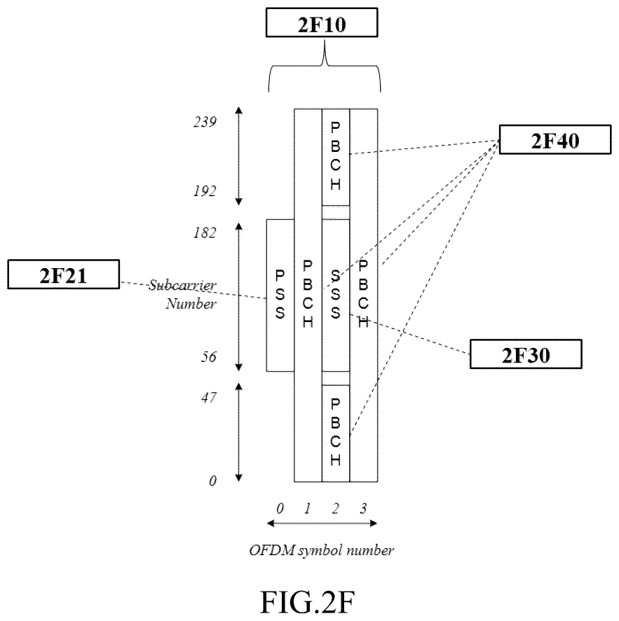

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
1: transmission of RRCSetupRequest by the UE 2B11;
1: reception of RRCSetup by the UE 2B21;
1: transmission of RRCSetupComplete by the UE 2B31.

Unsuccessful RRC connection establishment procedure comprises:
1: transmission of RRCSetupRequest by the UE 2B41;
1: reception of RRCReject by the UE 2B51;

RRCSetupRequest comprises following fields and IEs:
1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc RRCSetup comprises following fields and IEs:
1: radioBearerConfig field containing a RadioBeareiConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCellGroup;
1: perform the radio bearer configuration procedure in accordance with the received radioBeareiConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-IdentityInfoList;
1: include the s-NSSAI-List and set the content to the values provided by the upper layers;

FIG. 2C illustrates UE capability transfer procedure.

For network to configure the UE with appropriate configurations, the network needs to know the capability of the UE. For this end, the UE and the base station perform UE capability transfer procedure.

UE capability transfer procedure consists of exchanging UECapabilityEnquiry 2C11 and UECapabilityInformation 2C21 between the UE and the base station.

In the UECapabiliityEnquiry, the base station indicates which RAT is subject to capability reporting. UE transmits the capability information for the requested RAT in the UECapabilityInformation.

Once UECapabilityInformation is received, the capability information is uploaded to the AMF by the base station 2C31. When UE capability information is needed afterward, AMF provide it to the base station 2C41.

FIG. 2D illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2D11 and RRCReconfigurationComplete 2D61 between the base station and the UE.

RRCReconfiguration may comprises following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE; Upon reception of RRCReconfiguration, UE processes the IEs in the order as below. UE may:
1: perform the cell group configuration for MCG based on the received masterCellGroup 2D21;
1: perform the cell group configuration for SCG based on the received secondaryCellGroup 2D31;
1: perform the radio bearer configuration based on the received radioBearerConfig 2D41;
1: perform the measurement configuration based on the received measConfig 2D51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2E illustrates data transfer procedure in RRC_CONNECTED state.

The UE and the base station may perform procedures for power saving such as C-DRX 2E11. The configuration information for C-DRX is provided to the UE within cell group configuration in the RRCReconfiguration.

The UE and the base station may perform various procedures for downlink scheduling 2E21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2E31. The base station transmits to the UE PDSCH corresponding to the DCI and containing a MAC PDU 2E41.

The UE and the base station may perform various procedure for uplink scheduling 2E51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2E61. The base station transmits to the UE PDSCH corresponding to the DCI and containing a MAC PDU 2E71.

The Synchronization Signal and PBCH block (SSB) 2F10 consists of primary synchronization signals (PSS) 2F20 and secondary synchronization signals (SSS) 2F30. PSS and SSS occupies 1 symbol and 127 subcarriers. PBCH 2F40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

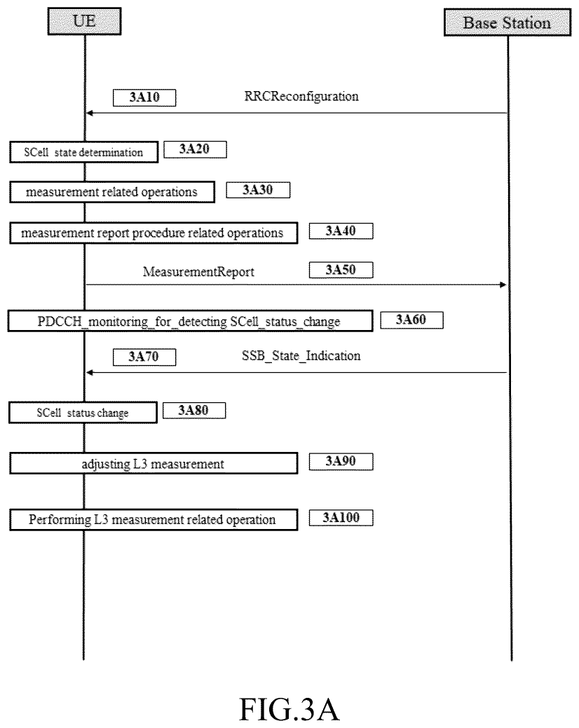

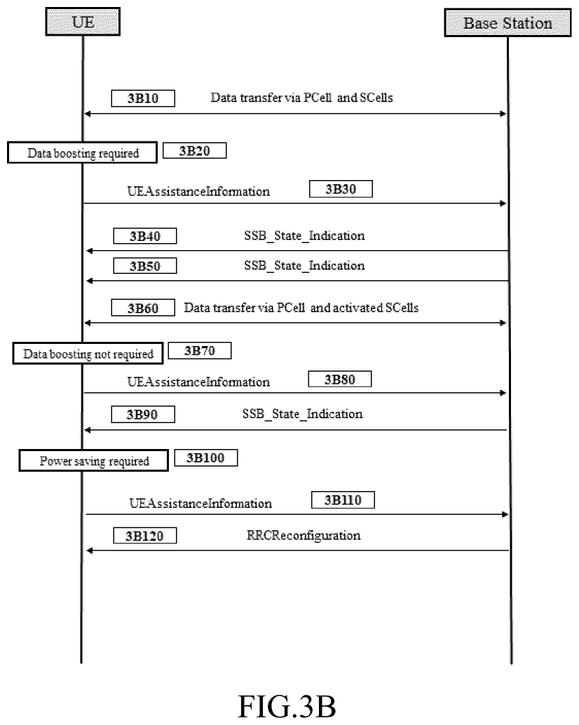

FIG. 3A illustrates the operations for SSB-less SCell that operates demand-driven manner.

In Rel-18 NES, SSB-less SCell operation is limited to the scenario of inter-band CA for FR1 and co-located cells.

In the Rel-18 NES, for SSB-less SCell to work properly, at least one SCell having similar radio characteristics and similar geographical condition is required to transmit SSB continuously. Then UE performs the necessary operation for the SSB-less SCell such as time/frequency synchronization, L1/L3 measurements and SCell activation based on the associated SCell.

One scenario that Rel-18 SSB-less SCell does not cover is when only one FR2 SCell is configured to the UE. Then, since the FR2 SCell does not have associated SCell (having similar radio characteristics and similar geographical condition), FR2 SCell is forced to transmit SSB continuously.

To overcome such restriction, it is necessary to define a new set of operations between the UE and GNBs that enables dynamic turning on>off SSB transmissions.

In the new set of operations, GNB may switch the type/status/state of an SCell.

Table 1 below explains three states of the SCell.

TABLE 1

| | | Deactivated SCell with | Deactivated SCell without |
|---|---|---|---|
| | Active SCell (A-SCell) | SSB transmission (D1-SCell) | SSB transmission (D2-SCell) |
| Characteristics | most power consuming; | less power consuming | least power consuming; |
| | and shortest latency | than A-SCell; and longer | and longest latency for |
| | for data transmission > | latency for data | data transmission > |
| | reception. | transmission > reception | reception (SCell |
| | | (SCell activation is | activation and SSB |
| | | required before data | transmission activation |
| | | transmission > reception). | are required before data |
| | | | transmission > reception). |
| PDCCH | UE monitors PDCCH | UE does not monitor PDCCH | UE does not monitor PDCCH |
| PUSCH/PUCCH/SRS | UE transmit | UE does not transmit | UE does not transmit |
| | PUSCH/PUCCH/SRS | PUSCH/PUCCH/SRS | PUSCH/PUCCH/SRS |
| CSI reporting | UE report CSI | UE does not report CSI | UE does not report CSI |
| CSI measurement | UE measure CSI | UE does not measure CSI | UE does not measure CSI |
| SSB measurement | UE measure SSB with a | UE measures SSB with a | UE does not measure SSB |
| | periodicity determined | periodicity determined | |
| | based on DRX cycle | based on DRX cycle and | |
| | | measCycleSCell | |
| Beam Management | UE performs BM based | UE does not perform BM | UE does not perform BM |
| | on CSI | | |
| L3 RRM | Serving cell | Serving cell | No serving cell |
| measurement | measurement for A1 and A2 | measurement for A1 and A2 | measurement for A1 and A2 |
| | Applicable cell for A3 | Applicable cell for A3 | Not applicable cell for A3 |
| | and A5 Measurement | and A5 Measurement | and A5 Measurement |
| | results reported in | results reported in | results reported in |
| | MeasurementReport | MeasurementReport | MeasurementReport |

Based on traffic load and channel condition of a UE, GNB determines which state to be applied and performs necessary procedure for state transition. The transition is performed between the adjacent states/types (i.e. from A-SCell to D1-SCell or vice versa; from D1-SCell to D2-SCell or vice versa). Transition between A-SCell and D1-SCell is performed based on SCell Activation/Deactivation MAC CE. Transition between D-SCell and D2-SCell is performed based on DCI 2_10. Transition from D2-SCell to A-SCell can be performed based on SCell Activation>Deactivation MAC CE (if a SCell is activated by the SCell Activation/Deactivation MAC CE and if the SCell is D2-SCell, transition from D2-SCell to A-SCell occurs; UE determines that SSB transmission of the serving cell will start at slot n+m3).

DCI 2_10 causes one or more UEs to change the status of a SCell. SCell A/D MAC CE causes a single UE to change the status of a SCell.

Table 2 summarizes state transitions.

TABLE 2

| State transition | | |
|---|---|---|
| direction | State transition caused by | State transition delay |
| A-SCell → D1-SCell | Reception of A/D MAC CE (the | When MAC CE is received in slot n, UE start |
| | corresponding Ci bit is set to 0 | operations related to D1-SCell at slot n + k. |
| | and the SCell was activated | # k = m + 3# x + 1. |
| | prior to receiving the A/D MAC | # slot n + m is a slot where HARQ-ACK for the |
| | CE); or | MAC CE is indicated. |
| | Expiry of | # x is number of slots per subframe for the SCS |
| | sCellDeactivation Timer | configuration of the PUCCH transmission. |
| | associated with SCell | |
| D1-SCell → A-SCell | Reception of A/D MAC CE (the | When MAC CE is received in slot n, UE start |
| | corresponding Ci bit is set to 1 | operations related to A-SCell at slot n + k. |
| | and the SCell was deactivated | # k = m + 3# x + 1. |
| | prior to receiving the A/D MAC | # slot n + m is a slot where HARQ-ACK for the |
| | CE) | MAC CE is indicated. |
| | | # x is number of slots per subframe for the SCS |
| | | configuration of the PUCCH transmission. |
| D1-SCell → D2-SCell | Reception of DCI 2_10 (A | When DCI 2_10 is received in slot n of serving |
| | specific bit in block whose | cell a, UE starts operations related to D2-SCell |
| | block number corresponds to | at slot n + h of serving cell b. |
| | the SCell is set to 0 and the | # h = c + y; |
| | SCell was D1-SCell prior to | # c is a parameter having a different value |
| | receiving DCI 2_10) | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where DCI |
| | | 2_10 is received. |
| | | # Serving cell b is the serving cell of which |
| | | status changes based on the received DCI 2_10 |
| | | (e.g. the concerned SCell) is to occur. |
| | | # The specific DL BWP of the serving cell b is |
| | | the BWP indicated by |
| | | firstActiveDownlinkBWP-Id of the serving cell |
| | | b or is initialDownlinkBWP of the serving cell |
| | | b. |
| | | # The specific DL BWP of the serving cell a is |
| | | the BWP where DCI 2_10 is received (or DCI |
| | | 2_10 is configured). |
| | | # y is: |
| | | ## 0 if SCS of the specific DL BWP of the |
| | | serving cell where DCI 2_10 is received and |
| | | SCS of the specific DL BWP of the SCell are |
| | | same; |
| | | ## otherwise, 1. |
| D2-SCell → D1-SCell | Reception of DCI 2_10 (A | When DCI 2_10 is received in slot n of serving |
| | specific bit in block whose | cell a, UE starts operations related to D1-SCell |
| | block number corresponds to | at slot n + h of serving cell b. |
| | the SCell is set to 1 and the | # h = c + y; |
| | SCell was D1-SCell prior to | # c is a parameter having a different value |
| | receiving DCI 2_10) | depending on a specific SCS. If the specific |
| | | SCS is 15KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving |
| | | cell a. |
| | | ## Serving cell a is the serving cell where DCI |
| | | 2_10 is received. |
| | | # Serving cell b is the serving cell of which |
| | | status changes based on the received DCI 2_10 |
| | | (e.g. the concerned SCell) is to occur. |
| | | # The specific DL BWP of the serving cell b is |
| | | the BWP indicated by |
| | | firstActiveDownlinkBWP-Id of the serving cell |
| | | b or is initialDownlinkBWP of the serving cell b. |
| | | # The specific DL BWP of the serving cell a is |
| | | the BWP where DCI 2_10 is received (or DCI |
| | | 2_10 is configured). |
| | | # y is: |
| | | ## 0 if SCS of the specific DL BWP of the |
| | | serving cell where DCI 2_10 is received and |
| | | SCS of the specific DL BWP of the SCell are same; |
| | | ## otherwise, 1. |
| D2-SCell → A-SCell | Reception of A/D MAC CE (the | When MAC CE is received in slot n, UE start |
| | corresponding Ci bit is set to 1 | operations related to D1-SCell at slot n + k. |
| | and the SCell was D2-SCell prior | # k = m + q # x + 1 |
| | to receiving the A/D MAC CE) | # slot n + m is a slot where HARQ-ACK for the |
| | | MAC CE is indicated. |
| | | # x is number of slots per subframe for the SCS |
| | | configuration of the PUCCH transmission. |
| | | # q is an integer greater than 3. q is fixed in the |
| | | specification and stored in ROM of the UE. |
| A-SCell → D2-SCell | Reception of DCI 2_10 (A | When DCI 2_10 is received in slot n of serving |
| | specific bit in block whose | cell a, UE starts operations related to D2-SCell |
| | block number corresponds to | at slot n + h of serving cell b. |
| | the SCell is set to 0 and the | # h = c + y; |
| | SCell was A-SCell prior to | # c is a parameter having a different value |
| | receiving DCI 2_10) | depending on a specific SCS. If the specific |
| | | SCS is 15 KHz, a is 1. If 30 KHz, a is 2. If 60 |
| | | KHz, a is 3. |
| | | # The specific SCS is the smallest one among: |
| | | ## SCS of a specific DL BWP of the serving |
| | | cell b; and |
| | | ## SCS of a specific DL BWP of the serving cell a. |
| | | ## Serving cell a is the serving cell where DCI |
| | | 2_10 is received. |
| | | # Serving cell b is the serving cell of which |
| | | status changes based on the received DCI 2_10 |
| | | (e.g. the concerned SCell) is to occur. |
| | | # The specific DL BWP of the serving cell b is |
| | | the BWP indicated by |
| | | firstActiveDownlinkBWP-Id of the serving cell |
| | | b or is initialDownlinkBWP of the serving cell b. |
| | | # The specific DL BWP of the serving cell a is |
| | | the BWP where DCI 2_10 is received (or DCI |
| | | 2_10 is configured). |
| | | # y is: |
| | | ## 0 if SCS of the specific DL BWP of the |
| | | serving cell where DCI 2_10 is received and |
| | | SCS of the specific DL BWP of the SCell are same; |
| | | ## otherwise, 1. |

At 3A10 UE receives from the GNB a RRCReconfiguration message. The RRCRecofniguration message comprises following fields/IEs.
measConfig field that comprises MeasConfig IE
spCellConfig field that comprises SpCellConfig IE
   newUE-Identity field that comprises RNTI-Value EE (for C-RNTI);
sCellToAddModList field that comprises one or more SCellConfig IEs; Each of SCellConfig may comprises:
   SSB_OFF_INDICATION field that indicates whether the SSB is transmitted in the corresponding SCell;
   positionInDCI_SSB_indication field that indicates the starting position of an information block of DC format 2_10 (e.g., SSB_State_Indication) for this serving cell;
   valid_measurement_window field that indicates the time duration related to validity of the measurements taken for SCells that have been changed to D2-SCell recently.
SSB_State_Indication configuration IE;
   cell_SSB_RNTI field that comprises RNTI for SSB_State_Indication;
   sizeDCI-2-10 field that indicates the size of SSB_State_Indication.

UE configures one or more SCells based on ServingCellConfigCommon IE and ServingCellConfig IE in SCellConifg. UE associates each SCell with a serving cell index. The serving cell index is derived from (or is equal to) SCellIndex IE. UE performs SCell state determination

At 3A20, UE performs SCell state determination.
For each SCell, UE determines state of each SCells:
   sCellState field is present in the SCellConfig IE, the corresponding SCell is in activated state (A-SCell);
   sCellState field is absent and SSB_OFF_INDICATION field is absent, the corresponding SCell is deactivated state with SSB transmission (D1-SCell);
   sCellState field is absent and SSB_OFF_INDICATION field is present, the corresponding SCell is deactivated state without SSB transmission (D2-SCell).

UE associates each SCell with a MeasObject based on servingCellMO field in the corresponding ServingCellConfig IE. UE configures measurements based on MeasConfig IE.

After performing configurations based on the RRCReconfiguration, UE transmits to the GNB a RRCReconfigurationComplete.

At 3A30, UE performs measurement related operations. UE may perform serving_cell_measurement_operation for each serving cell. UE determines, through the operation, which to measure and which to not measure.

<serving_cell_measurement_operation>
for each serving cell for which servingCellMO is configured, UE performs followings:
   if the serving cell is PCell or A-SCell or D1-SCell;
      UE measure SS/PBCH blocks of the serving cell based on SSB-ToMeasure in the MeasObjectNR IE indicated by corresponding servingCellMO (or based on SSB-ToMeasure in the ServingCellConfigCommon); and
      UE derive layer 3 filtered RSRP and RSRQ per beam for the serving cell based on SS/PBCH block;
   if the serving cell is D2-SCell;
      UE does not measure SS/PBCH blocks of the serving cell;
      UE does not derive layer 3 filtered RSRP and RSRQ per beam for the serving cell.

UE performs evaluation on measurement report triggering. UE may perform, following in the order:
applicable_cell_determination to determine applicable cells and neighbouring cells;
determining_whether_to_perform_measurement_reporting_triggering_evaluation;
measurement_report_triggering_evaluation;
measurement_report_initiating_on_entering or measurement_report_initiating_on_leaving or both; and
cellTriggeredList_upadte.

UE performs following for applicable_cell_determination.
For first type event,
   For a measId that is configured with a first type event (alternatively, for each measId, for which the first type event is configured in the corresponding reportConfig):
      UE considers only the serving cell to be applicable for the first type event (alternatively, UE consider a specific SCell to be applicable for the event; the specific SCell is the SCell that is associated with a specific measObject; the specific measObject is associated with a specific reportConfig; the specific reportConfig configures the first type event).
For second type event,
   For a measId that is configured with a second type event (alternatively, for each measId, for which the second type event is configured in the corresponding reportConfig):
      if the concerned measObjectNR (the measObjectNR associated with the measId) is associated with a SCell; and
      if the SCell associated with the measObjectNR is A-SCell or D1-SCell;
         UE considers the SCell to be a neighbouring cell;
         if useAllowedCellList is set to true and if the SCell is included in the allowedCellsToAddModList,
         UE considers the SCell to be applicable.
         if useAllowedCellList is set to true and if the SCell is not included in the allowedCellsToAddModList,
         UE considers the SCell to be not applicable.
         if useAllowedCellList is set to false and if the SCell is not included in the excludedCellsToAddModList,
         UE considers the SCell to be applicable.
         if useAllowedCellList is set to false and if the SCell is included in the excludedCellsToAddModList,
         UE considers the SCell to be not applicable.
      if the SCell associated with the measObjectNR is D2-SCell,
      UE considers the SCell neither neighbouring cell nor to be applicable.
For third type event,
   For a measId that is configured with a third type event (alternatively, for each measId, for which the third type event is configured in the corresponding reportConfig):
      if the concerned measObjectNR (the measObjectNR associated with the measId) is associated with a SCell,
         UE considers the SCell neither neighbouring cell nor to be applicable.

UE performs followings for determining_measurement_report_triggering_evaluation.

<determining_whether to_perform_measurement_report_triggering_evaluation>
For first type event,
   For a measId that is configured with a first type event (alternatively, for each measId, for which the first type event is configured in the corresponding reportConfig):
      if the applicable cell for the first type event is A-SCell or D1-SCell,
         UE determines to perform measurement_reporting_triggering_evaluation for the measId;
      if the applicable cell for the first type event is D2-SCell,
         UE determines to not perform measurement_report_triggering_evaluation for the measId (and determines to perform neither measurement_report_initiating_on_entering nor measurement_report_initiating_on_leaving);
         UE determines to perform measurement_report_triggering_evaluation for the measId when a specific DCI 2_10 is received.
For second type event and third type event,
   For a measId that is configured with a second type event or a third type event:
      UE determines to perform measurement_report_triggering_evaluation for the measId.

UE determines types of events as follows.
First type event is an event that is related only to a specific serving cell.
   The specific serving cell is PCell or SCell that is associated with the corresponding ReportConfig (i.e. ARFCN of the serving cell is same as ARFCN of MeasObjectNR associated with the ReportConfiig #MeasId).
   Only the specific serving cell is applicable.
   Event A1 and Event A2 are first type event.
Second type event is an event that is related to a specific serving cell and one or more neighbouring cells.
   The specific serving cell is PCell.
   The one or more neighbouring cells comprises:
      neighbouring cells detected based on parameters in the associated measObjectNR; and
      SCell associated with the corresponding ReportConfig (i.e. ARFCN of the serving cell is same as ARFCN of MeasObjectNR associated with the ReportConfiig #MeasId).
   Some of the one or more neighbouring cells are applicable.
   Event A3 and Event A5 are second type event
Third type event is an event that is related to only neighbouring cells.
   The one or more neighbouring cells are neighbouring cells detected based on parameters in the associated measObjectNR.
   Some of the one or more neighbouring cells are applicable.
   Event A4 is third type event

UE performs followings for measurement_report_triggering_evaluation.

<measurement_report_triggering_evaluation>
For measurement_report_triggering_evaluation for an event (or for a measId associated with the event);
   UE determines to trigger measurement_report_initiating_on_entering if the following conditions are fulfilled.
      the entry condition applicable for this event is fulfilled for one or more applicable cells for all measurements after layer 3 filtering taken during timeToTrigger defined for this event; and
      at least one of the one or more applicable cells is not included in the cellsTriggeredList.
   UE determines to trigger measurement_report_initiating_on_leaving if the following conditions are fulfilled.
      the leaving condition applicable for this event is fulfilled for one or more applicable cells for all measurements after layer 3 filtering taken during timeToTrigger defined for this event; and
      at least one of the one or more applicable cells is included in the cellsTriggeredList.

<measurement_report_initiating_on_entering>

For measurement_report_initiating_on_entering for a measId, UE may:
include the measurement reporting entry within the VarMeasReportList for this measId, if not included yet;
include the concerned cell(s) in the cellsTriggeredList defined within the VarMeasReportList for this measId (the concerned cell is the cell that triggered the measurement_report_initiating_on_entering);
if useT312 is set to true in reportConfig for this event:
   if T310 for the corresponding SpCell is running; and
   if T312 is not running for corresponding SpCell:
      start timer T312 for the corresponding SpCell with the value of T312 configured in the corresponding measObjectNR;
initiate the measurement reporting procedure.

<measurement_report_initiating_on_leaving>

For measurement_report_initiating_on_leaving for a measId, UE may:
remove the concerned cell(s) in the cellsTriggeredList defined within the VarMeasReportList for this measId (the concerned cell is the cell that triggered the measurement_report_initiating_on_leaving);
if reportOnLeave is set to true for the corresponding reporting configuration
   initiate the measurement reporting procedure, as specified in 5.5.5;
if the cellsTriggeredList defined within the VarMeasReportList for this measId is empty:
   remove the measurement reporting entry within the VarMeasReportList for this measId; UE performs followings for cellsTriggeredList_update.

For cellsTriggeredList_update for a measId, UE may:
if the entry condition applicable for the event associated with the measId is fulfilled for one or more cells for all measurements after layer3 filtering taken during timeToTriggered; and
if the one or more cells are not included in cellTriggeredList:
   include the one or more cells in the cellsTriggeredList for the MeasId; and
   initiate the measurement reporting procedure;
if the leaving condition applicable for the event associated with the measId is fulfilled for one or more of the cells for all measurements after layer3 filtering taken during timeToTriggered; and
if the one or more cells are included in cellTriggeredList:
   remove the one or more cells in the cellsTriggeredList for the MeasId; and
   initiate the measurement reporting procedure.

UE may remove a specific cell from cellTriggeredList in case that the cell state changes from A-SCell or D1-SCell to D2-SCell (due to reception of SSB_State_Indication). In this case, UE does not initiate the measurement reporting procedure for the MeasId even when the associated ReportConfig is configured with reportOnLeave.

At 3A40, UE performs measurement report procedure related operations as follows.

UE triggers measurement report procedure based on the measurement related operations (e.g. based on determination whether to trigger measurement reporting procedure). Based on the determination, UE performs measurement reporting procedure. For measurement reporting procedure, UE may perform measurement_result_inclusion.

UE performs followings for measurement_result_inclusion through which UE may determine which serving cell's measurement result shall be included in the measurement report message.

<measurement_result_inclusion>
for each serving cell configured with servingCellMO,
   if the serving cell is PCell or A-SCell or D1-SCell,
      include the MeasResultServMO IE of the serving cell in the MeasResultServMOList IE;
   if the serving cell is D2-SCell, and if L3 filtered measurement results for D2-SCell determined within the valid_measurement_window is available (i.e. D2-SCell was D1-SCell at least valid_measurement_window before),
      include the corresponding MeasResultServMO IE in the MeasResultServMOList IE,
   if the serving cell is D2-SCell, and if L3 filtered measurement results for D2-SCell determined within valid_measurement_window is not available;
      not include the corresponding MeasResultServMO IE in the MeasResultServMOList IE.

Alternatively,
for each serving cell configured with servingCellMO,
   if the serving cell is PCell or A-SCell or D1-SCell,
      include the type1_MeasResultServMO IE of the serving cell in the MeasResultServMOList IE;
   if the serving cell is D2-SCell, and if L3 filtered measurement results for D2-SCell determined within valid_measurement_window is available (i.e. D2-SCell was D1-SCell at least valid_measurement_window before),
      include the type1_MeasResultServMO IE in the MeasResultServMOList IE,
   if the serving cell is D2-SCell, and if L3 filtered measurement results for D2-SCell determined within valid_measurement_window is not available;
      include the type2_MeasResultServMO IE in the MeasResultServMOList IE.

type1_MeasResultServMO IE comprises followings:
servCellId field that comprises ServCellIndex;
measResultServingCell field that comprises:
   physCellId field that comprises PhysCellId of the serving cell;
   resultsSSB-Cell field or resultsCSI-RS-Cell field that comprises RSRP #RSRQ of the serving cell;
   rsIndexResults field that comprises beam level measurement results of the serving cell;
measResultBestNeighCell field that comprises:
   physCellId field that comprises PhysCellId of the best neighboring cell;
   resultsSSB-Cell field or resultsCSI-RS-Cell field that comprises RSRP #RSRQ of the best neighboring cell;
   rsIndexResults field that comprises beam level measurement results of the best neighboring cell.

type2_MeasResultServMO IE comprises followings:
servCellId field that comprises ServCellIndex;
   measResultServingCell field that comprises:
      physCellId field that comprises PhysCellId of the serving cell;
   measResultBestNeighCell field that comprises:
      physCellId field that comprises PhysCellId of the best neighboring cell;
      resultsSSB-Cell field or resultsCSI-RS-Cell field that comprises RSRP #RSRQ of the best neighboring cell;
      rsIndexResults field that comprises beam level measurement results of the best neighboring cell.

At 3A50, UE transmits to GNB a MeasurementReport. The MeasurementReport comprises a MeasResultServMOList. GNB may determine to change the states of one or more SCells based on the measurement report. GNB may transmit SSB_State_Indication to change the state of the one or more SCells.

UE performs PDCCH_monitoring_for detecting SCell_status_change.

UE performs followings for PDCCH_monitoring_for_detecting SCell_status_change.

<PDCCH_monitoring_for_detecting SCell_status_change>
For SSB_State_Indication reception, UE monitors SSB_State_Indication_CSS in one or more specific serving cells based on SSB_State_Indication_RNTI;
   configuration parameters for SSB_State_Indication_CSS is comprised in the SpCellConfig IE;
   the one or more specific serving cells may be:
      a PCell; and
      one or more SCells that is activated and of which active BWP is configured with the SSB_State_Indication_CSS;
For SCell A/D MAC CE reception, UE monitors USS based on C-RNTI in all serving cells that is currently activated;
   configuration parameters for USS is comprised in the SCellConfig IE and in SpCellConfig IE.

At 3A70, UE receives from GNB SSB_State_Indication. The SSB_State_Indication is carried in DCI format 2_10 or in a MAC CE. SSB_State_Indication indicates, for each cell:
SSB transmission will stop in a specific time point;
SSB transmission will start in a specific time point;
SSB transmission will continue; or
No SSB transmission will continue.

<DCI format 2_10>

DCI format 2_10 is used for activating or de-activating the SSB transmission of one or multiple SCells for one or more UEs.

The following information is transmitted by means of the DCI format 2_10 with CRC scrambled by cell_SSB_RNTI:
block number 1, block number 2, . . . , block number N
   the starting position of a block associated with a serving cell is determined by the parameter positionInDCI_SSB_indication provided by higher layers (in a RRCReconfiguration) for the UE.

If the UE is configured to monitor DCI 2_10 with CRC scrambled by cell_SSB_RNTI, one or more blocks are configured for the UE by higher layers (in a RRCReconfiguration), with the following fields defined for each block:
SSB indication—number of bits determined by the following:
   If higher layer parameter positionInDCI_SSB_indication is configured
      1 bit; 0 indicates that SSB transmission is deactivated (no SSB transmission in the corresponding cell); 1 indicates that SSB transmission is activated (SSB is transmitted in the corresponding cell)
      0 bit otherwise.
SSB time offset—number of bits determined by the following:
   If higher layer parameter time_offset_InDCI_SSB_indication is configured
      5 bit; 0 indicates that SSB transmission is activated or deactivated in a predefined time point; 1 indicates that SSB transmission is activated or deactivated in the first SSB transmission occasion after slot n (or symbol n); . . . ; 31 indicates that SSB transmission is activated or deactivated in the 31-th SSB transmission occasion after symbol n; slot n (or symbol n) is the slot (symbol) that the DCI 2_10 is received. The SSB transmission occasion is determined from SSB-ToMeasure in the ServingCellConfigCommon of the SCell.
      0 bit otherwise.

The size of DCI format 2_10 is indicated by the higher layer parameter sizeDCI-2-10.

A block in DCI 2_10 is either a 6 bit or a single bit or a zero bit. Each block is associated with a SCell. The association between the block and the SCell (serving cell) is indicated by the parameter positionInDCI_SSB_indication field in the serving cell configuration information for the SCell. The highest possible value for positionInDCI_SSB_indication is first integer.

A Ci bit in SCell A/D MAC CE is a single bit. Each Ci bit is associated with a SCell. The association between the Ci and the SCell is derived from SCell index. The highest possible value for SCell index is second integer.

The first integer is greater than the second integer because the first integer is related with serving cells of plurality of terminals while the second integer is related with serving cells of a single terminal.

At 3A80, UE performs, based on DCI 2_10, SCell_status_change_determination. UE determines, for a SCell, whether the SSB transmission in the SCell is activated or deactivated based on received DCI 2_10.

<beam_failure_operation>

If a DCI 2_10 is received at slot n of a first cell (one of one or more specific serving cells) and the DCI 2_10 contains information that cause A-SCell to transition to D2-SCell, UE performs beam_failure_operation:

UE may, for the SCell:
set BFI_COUNTER of each BFD-RS set of SCell to 0;
consider the Beam Failure Recovery procedure successfully completed and cancel all the triggered BFRs of all BFD-RS sets of the Serving Cell.

When a DCI 2_10 is received at slot n of the first cell, UE performs:
beam_failure_operation for the second cell at a first point of time;
   the first point of time is n+number of slots per subframes of a specific BWP of the second cell; the specific BWP is firstActiveUplinkBWP or initialUplinkBWP;
CSI reporting on the serving cell at a second point of time;
   the second point of time is n+3*number of slots per subframe of a specific BWP of a third cell; the third cell is the cell where CSI on PUCCH is transmitted; the specific BWP is UL BWP where CSI on PUCCH is transmitted.
The first point of time is earlier than the second point of time.

When a SCell is deactivated, UE stops actions related to CSI reporting on a serving cell (e.g. PCell or PUCCH SCell):
at n+k if SCell deactivation is caused by SCell A/D MAC CE (e.g. deactivation command in a PDSCH);
   k is m+3*number of slots per subframe of a specific BWP of a third cell;
   the third cell is the cell where CSI on PUCCH is transmitted;
   the specific BWP is UL BWP where CSI on PUCCH is transmitted;
   n is a slot where UE receives a deactivation command for the SCell in PDSCH;
   n+m is a slot indicated for PUCCH transmission with HARQ-ACK information for the PDSCH reception (e.g. slot where HARQ ACK for SCell A/D MAC CE is transmitted)
at n+h if SCell deactivation is caused by DCI 2_10 (e.g. deactivation command in PDCCH);
   h is 3*number of slots per subframe of a specific BWP of a third cell;
   the third cell is the cell where CSI on PUCCH is transmitted;
   the specific BWP is UL BWP where CSI on PUCCH is transmitted;
   n is a slot where UE receives a deactivation command for the SCell in PDCCH;
at the first slot after slot n+j;
   j is 3*number of slots per subframe of a specific BWP of the SCell;
   the specific BWP is the active DL BWP of the SCell;

<SCell_status_change_determination>

A DCI 2_10 is received at slot n of a first cell (one of one or more specific serving cells) and the DCI 2_10 contains information related to a second cell:
if [SSB indication in a block number M that corresponds to the second sell is set to 0] and [the second cell is activated when DCI 2_10 is received (e.g. the second cell is A-SCell];
   UE determines that SSB transmission of the second cell will stop at specific time point of the second cell (or UE determines that SSB of the second cell will be unavailable after specific time point of the second cell);
   UE determines that SCell changes from A-SCell to D2-SCell (e.g. state transition from D1-SCell to D2-SCell occurs).
if [SSB indication in a block number M that corresponds to the second sell is set to 0] and [the second cell is not activated when DCI 2_10 is received] and [the SSB has been transmitted in the second cell before the reception of DCI 2_10 (e.g. the second cell is D1-SCell)];
   UE determines that SSB transmission of the second cell will stop at specific time point of the second cell (or UE determines that SSB of the second cell will be unavailable after specific time point of the second cell);
   UE determines that SCell changes from D1-SCell to D2-SCell (e.g. state transition from D1-SCell to D2-SCell occurs).
if [a block number M that corresponds to the second cell is set to 1] and [the second cell is not activated when DCI 2_10 is received] and [the SSB was not transmitted in the second cell before the reception of DCI 2_10 (e.g. the SCell is D2-SCell)];
   UE determines that SSB transmission of the second cell will start at specific time point of the second cell (or UE determines that SSB of the second cell will be available after specific time point of the second cell);
   UE determines that the SCell changes from D2-SCell to D1-SCell (e.g. state transition from D2-SCell to D1-SCell occurs).
if [a block number M that corresponds to a second cell is set to 1] and [the second cell is not activated when DCI 2_10 is received] and [the SSB has been transmitted in the second cell before the reception of DCI 2_10 (e.g. the second cell is D1-SCell)];
   UE determines that SSB transmission of the second cell does not change (e.g. continue before and after reception of the DCI 2_10);
   UE determines that second cell stay as D1-SCell (e.g. state transition does not occur).
if [a block number M that corresponds to a second cell is set to 0] and [the second cell is not activated when DCI 2_10 is received] and [the SSB has been transmitted before the reception of DCI 2_10 (e.g. the second cell is D2-SCell)];
   UE determines that SSB transmission of the second cell does not change (e.g. no SSB transmission before and after reception of the DCI 2_10);
   UE determines that second cell stay as D2-SCell (e.g. state transition does not occur).

UE may ignore block number M if the corresponding second cell is A-SCell.

The specific time point is either slot n+h or determined from SSB time offset.

A SCell A/D MAC CE is received at slot n of a third cell (a serving cell among currently active serving cells) and the SCell A/D MAC CE contains information related to the second cell:
if [Ci bit that corresponds to the second cell is set to 1] and [the second cell is not activated when the SCell A/D MACE is received] and [the SSB has been transmitted before the reception of SCell A/D MAC CE (e.g. the second cell is D2-SCell)]
   UE determines that SSB transmission of the second cell will start at slot n+k #x+1 of the second cell (or UE determines that SSB of the second cell will be available after slot n+k #x+1 of the second cell);
   UE determines that the SCell changes from D2-SCell to A-SCell (e.g. state transition from D2-SCell to A-SCell occurs).

At 3A90, UE performs, considering the changed status, measurement related operations.
UE may perform serving_cell_measurement_operation_adjusted for each SCell.
UE performs evaluation on measurement report triggering.
   UE performs applicable cell_determination_after_SCell_status_change to determine applicable cells and neighbouring cells.
   UE performs determining_whether_to_perform_measurement_reporting_triggering_evaluation_after_SCell_status_change for measId configured with the first type event.
   UE performs measurement_report_triggering_evaluation.
   UE performs measurement_report_triggering_evaluation.
   UE may perform measurement_report_initiating_on_entering or measurement_report_initiating_on_leaving orboth.
   UE may perform cellTriggeredList_upadte.

For serving_cell_measurement_operation_adjusted, UE performs as follows.

<serving_cell_measurement_operation_adjusted>
for each SCell for which servingCellMO is configured, UE performs followings:
   if the SCell was A-SCell or D1-SCell before reception of DCI 2-10; and
   if the SCell becomes D2-SCell due to reception of DCI 2-10 at slot n of a serving cell;
      UE performs followings at slot n+1 of the serving cell:
         stop measuring SS/PBCH blocks of the SCell;
         stop deriving layer 3 filtered RSRP and RSRQ per beam for the SCell (e.g. initialize Mn, Fn and Fn−1 to zero);
         remove the SCell in relevant cellsTriggeredList (to prevent D2-SCell fulfilling leaving condition and triggering measurement report procedure) where the SCell was included.
if the SCell was D2-SCell; and
   if the SCell becomes D1-SCell due to reception of DCI 2-10 at slot n of a serving cell;
      UE performs followings at slot n+c+y of the SCell:
         start measuring SS/PBCH block of the SCell based on SSB-ToMeasure in the ServingCellConfigCommon of the SCell;
         start deriving filtered RSRP and RSRQ per beam for the SCell (e.g. start updating Fn based on Mn and Fn-1)
   if the SCell becomes A-SCell due to reception of SCell A/D MAC CE at slot n of a serving cell;
      UE performs followings at slot n+m of a serving cell where HARQ ACK is transmitted;
         start measuring SS/PBCH block of the SCell based on SSB-ToMeasure in the ServingCellConfigCommon of the SCell;
         start deriving filtered RSRP and RSRQ per beam for the SCell (e.g. start updating Fn based on Mn and Fn−1)

<applicable_cell_determination_after_SCell_status_change>
For first type event: (same as applicable_cell_determination),
   For a measId that is configured with a first type event (alternatively, for each measId, for which the first type event is configured in the corresponding reportConfig):
      UE considers only the serving cell to be applicable for the first event (alternatively, UE consider a specific SCell to be applicable for the event; the specific SCell is the SCell that is associated with a specific measObject; the specific measObject is associated with a specific reportConfig; the reportConfig configures the first type event).
For second type event,
   For a measId that is configured with a second type event (alternatively, for each measId, for which the second type event is configured in the corresponding reportConfig):
      if the concerned measObjectNR (the measObjectNR associated with the measId) is associated with a SCell,
         if the SCell associated with the measObjectNR was A-SCell or D1-SCell before reception of DCI 2_10 and becomes D2-SCell due to reception of DCI 2_10; or
         if the SCell associated with the measObjectNR was D2-SCell before reception of DCI 2_10 and continues to be D2-SCell due to reception of DCI 2_10,
         UE considers the SCell neither neighbouring cell nor to be applicable.
         if the SCell associated with the measObjectNR was D2-SCell before reception of DCI 2_10 and becomes D2-SCell due to reception of DCI 2_10; or
         if the SCell associated with the measObjectNR was A-SCell or D1-SCell before reception of DCI 2_10 and continues to be A-SCell or D1-SCell due to reception of DCI 2_10,
         UE considers the SCell to be a neighbouring cell as well;
         if useAllowedCellList is set to true and if the SCell is included in the allowedCellsToAddModList,
         UE considers the SCell to be applicable.
         if useAllowedCellList is set to true and if the SCell is not included in the allowedCellsToAddModList,
         UE considers the SCell to be not applicable.
         if useAllowedCellList is set to false and if the SCell is not included in the excludedCellsToAddModList,
         UE considers the SCell to be applicable.
         if useAllowedCellList is set to false and if the SCell is included in the excludedCellsToAddModList,
         UE considers the SCell to be not applicable.
         if the SCell associated with the measObjectNR is D2-SCell,
         UE considers the SCell neither neighbouring cell nor to be applicable.
For third type event (same as applicable_cell_determination),
   For a measId that is configured with a third type event (alternatively, for each measId, for which the third type event is configured in the corresponding reportConfig):
      if the concerned measObjectNR (the measObjectNR associated with the measId) is associated with a SCell,
         UE considers the SCell neither neighbouring cell nor to be applicable.

<determining_whether_to_perform_measurement_report_triggering_evaluation_after_SCell_status_change>
For first type event:
   For a measId that is configured with a first type event (alternatively, for each measId, for which the first type event is configured in the corresponding reportConfig):
      if the applicable cell for the first type event becomes A-SCell or D1-SCell due to reception of DCI 2_10 or SCell A/D MAC CE; and
      if the applicable cell was D2-SCell before the reception of DCI2_10 or SCell A/D MAC CE;
         UE determines to start measurement_reporting_triggering_evaluation for the measId;
      if the applicable cell for the first type event becomes D2-SCell due to reception of DCI 2_10; and
      if the applicable cell was D1-SCell or A-SCell before the reception of DCI2_10;
         UE determines to stop measurement_reporting_triggering_evaluation for the measId;

<cellsTriggeredList_update_after_SCell_status_chagne>

For cellsTriggeredList_update_after_SCell_status_change for a measId, UE may:
if a one or more cells included in the cellsTriggeredList becomes D2-SCell due to reception of DCI 2_10;
   remove the one or more cells in the cellsTriggeredList for the MeasId; and
   not initiate the measurement reporting procedure.
if the entry condition applicable for the event associated with the measId is fulfilled for one or more cells for all measurements after layer3 filtering taken during timeToTriggered; and
if the one or more cells are not included in cellTriggeredList:
   include the one or more cells in the cellsTriggeredList for the MeasId; and
   initiate the measurement reporting procedure;
if the leaving condition applicable for the event associated with the measId is fulfilled for one or more of the cells for all measurements after layer3 filtering taken during timeToTriggered; and
if the one or more cells are included in cellTriggeredList:
   remove the one or more cells in the cellsTriggeredList for the MeasId; and
   initiate the measurement reporting procedure.

At 3A100, UE performs measurement related operations based on the adjustment.

UE may perform followings for operations illustrated in FIG. 3A.

UE may determine to perform, for each measId, that is configured #associated with first type event (event related to serving cell only; event A1 and #or event A2), measurement_report_triggering_evaluation based on whether the applicable cell is D2-SCell or not.

UE may perform, for each measId that is configured #associated with second type event (event related to both serving cell and neighbouring cell; event A3 and #or A5), measurement_report_triggering_evaluation_type2.

<measurement_report_triggering_evaluation_type1>

For measId of which corresponding reportConfig is configured with first type event, UE determines whether to perform measurement_report_triggering_evaluation based on whether the applicable cell of the event is D2-SCell or not.

UE determines that applicable cell to the first type event is the SCell associated with the measObjectNR associated with the event.

UE determines to perform measurement_report_triggering_evaluation_type1 in case that the applicable cell is A-SCell or D1-SCell. UE determines to not perform measurement_report_triggering_evaluation_type1 in case that the applicable cell is D2-SCell.

For measId of which corresponding reportConfig is configured with eventA4, UE performs measurement_report_triggering_evaluation with applicable cells.

For each measId included in the measIdList within VarMeasConfig:
if event A1 or A2 is configured in the corresponding reportConfig:
   if the corresponding measObject is associated with A-SCell (e.g. 1: servingCellMO of the SCell indicates the measObjectId of the corresponding measObject and 2: the SCell is A-SCell) or if the corresponding measObject is associated with D1-SCell (e.g. 1: servingCellMO of the SCell indicates the measObjectId of the corresponding measObject and 2: the SCell is D1-SCell); and
   if the entry #leaving condition applicable for this event is fulfilled for the SCell for all measurements after layer 3 filtering taken during timeToTrigger defined for this event within the VarMeasConfig;
      UE performs measurement_reporting_operation for this measId:
   if the corresponding measObject is associated with D2-SCell (e.g. 1: servingCellMO of the SCell indicates the measObjectId of the corresponding measObject and 2: the SCell is D2-SCell);
      UE does not evaluate if the entry #leaving condition applicable for this event is fulfilled until a first point of time;
      UE start evaluating if the entry #leaving condition applicable for this event is fulfilled after the first point of time;
      UE does not perform measurement-reporting-operation for this measId until the first point of time; and
      UE performs measurement-reporting-operation for this measId after the first point of time.
      the first point of time is when D2-SCell change to D1-SCell (e.g. upon reception of SSB_ACTIVATION_COMMAND) For each measId included in the measIdList within VarMeasConfig:
if event A1 or A2 is configured in the corresponding reportConfig;
   if the applicable cell is A-SCell or D-SCell 1:
      UE performs measurement-reporting-operation;
   if the applicable cell is D2-SCell:
      UE does not perform measurement-reporting-operation for this measId.
if the eventA3 or eventA5 is configured in the corresponding reportConfig:
   UE evaluates whether the entry #leaving condition applicable for this event is fulfilled for one or more applicable cells (among applicable cells of this event) for all measurements after layer 3 filtering taken during timeToTrigger defined for this event within the VarMeasConfig;
   UE performs measurement-reporting-operation for this measId if entry condition or leaving condition is fulfilled for at least one applicable cell.

UE determines the one or more applicable cells of this event as below.
if the corresponding measObject is associated with A-SCell (e.g. 1: servingCellMO of the SCell indicates the measObjectId of the corresponding measObject and 2: the SCell is A-SCell) or if the corresponding measObject is associated with D1-SCell (e.g. 1: servingCellMO of the SCell indicates the measObjectId of the corresponding measObject and 2: the SCell is D1-SCell);
   applicable cells comprise:
      SCell associated with the measObject that is linked with the measId; and
      any neighbouring cell detected based on parameters in the associated measObjectNR when the concerned cell is not included in the excludedCellsToAddModList defined within the VarMeasConfig for this measId;
if the corresponding measObject is associated with D2-SCell
   applicable cells comprise:
      any neighbouring cell detected based on parameters in the associated measObjectNR and not included in the excludedCellsToAddModList defined within the VarMeasConfig for this measId;
   applicable cells do not comprise:
      SCell associated with the measObject that is linked with the measId; and
      any neighbouring cell included in the excludedCellsToAddModList defined within the VarMeasConfig for this measId.

For measurement-reporting-operation, UE includes a measurement reporting entry within the VarMeasReportList for this measId and UE initiates the measurement reporting procedure.

If SCell state transition occurs (or if SSB transmission status of a SCell changes), UE performs measurement according to the new status.

For each serving cell for which servingCellMO is configured and of which SSB transmission status changes, UE performs followings:
if D1-SCell becomes D2-SCell at slot n+m1 of the SCell due to reception of DCI 2_10 at slot n of PCell;
   UE stops measuring SS/PBCH of the SCell at slot n+m4 of the SCell;
   UE stops deriving layer 3 filtered RSRP and RSRQ per beam for the SCell at slot n+m3 of the SCell;
   UE reset parameters related to layer 3 filtering for the SCell (e.g. initialize Mn, Fn and Fn-1 to zero);
   UE remove the SCell in one or more cellsTriggeredList (to prevent D2-SCell fulfilling leaving condition and triggering measurement report procedure).
if D2-SCell becomes D1-SCell at slot n+m2 of the SCell due to reception of DCI 2_10 at slot n of PCell;
   UE starts measuring SS/PBCH of the SCell at slot n+m5 of the SCell;
      slot n+m5 is the slot where the first SS/PBCH since #after slot n+m2 is transmitted in the SCell. It is determined based on SSB-ToMeasure in the ServingCellConfigCommon.
   UE starts deriving layer 3 filtered RSRP and RSRQ per beam for the SCell at slot n+m6 of the SCell;
      slot n+m6 is the slot when the first measurement result from the physical layer since #after slot n+m5 becomes available.
if D2-SCell becomes A-SCell at slot n+m6 of the SCell due to reception of MAC CE at slot n of PCell;
   UE starts measuring SS/PBCH of the SCell at slot n+m7 of the SCell;
      slot n+m7 is the slot where the first SS/PBCH since #after slot n+m6 is transmitted in the SCell. It is determined based on SSB-ToMeasure in the ServingCellConfigCommon.
   UE starts deriving layer 3 filtered RSRP and RSRQ per beam for the SCell at slot n+m7 of the SCell;
      slot n+m7 is the slot when the first measurement result from the physical layer since #after slot n+m6 becomes available.

When UE is configured with one or more SCells (e.g. secondary component carriers), UE may prefer different configurations regarding SCells to achieve power saving or data boosting. If UE is short of battery power, UE may request GNB to change the SCell configurations in such a way that reduce the battery power. If UE expect data boosting will be required in the near future (e.g. when heavy traffic will occur due to high data rate applications such as XR is started), UE may request GNB to change the SCell status in such a way that available bandwidth for data transfer increases.

GNB may configure UE to transmit UAI in such cases. UE may initiate UE Assistance Information.

The purpose of this procedure is for the UE to inform the network of:
its preference on the maximum aggregated bandwidth for power saving, or;
its preference on the maximum number of secondary component carriers for power saving, or;
its preference on the minimum aggregated bandwidth across secondary component carriers for data boosting
its preference on the minimum number of secondary component carriers for data boosting

An example of UEAssistanceInformation is as below.

```
  UEAssistanceInformation ::= SEQUENCE {
    ....
    maxBW-Preference-r16  MaxBW-Preference-r16
OPTIONAL,
  //maximum aggregated bandwidth across all downlink carrier(s) and across all uplink
carrier(s) of FR1;
  // maximum aggregated bandwidth across all downlink carrier(s) and across all uplink
carrier(s) of FR2-1; and
  // maximom aggregated bandwidth across all downlink carrier(s) and across all uplink
carrier(s) of FR2-2
    maxCC-Preference-r16  MaxCC-Preference-r16
OPTIONAL,
  //maximum number of downlink SCells and uplink SCells
    minBW-Preference MinBW-Preference
OPTIONAL,
  //minimum aggregated bandwidth across all downlink secondary carrier(s) and across
all uplink secondary carrier(s) of FR1 and FR2-1 and FR2-2;
    minCC-Preference MinCC-Preference
OPTIONAL,
  // minimum number of downlink SCells and aplink SCells
    ....
  }
  MaxBW-Preference-r16 ::=  SEQUENCE {
    reducedMaxBW-FR1-r16  ReducedMaxBW-FRx-r16
OPTIONAL,
    reducedMaxBW-FR2-r16  ReducedMaxBW-FRx-r16
OPTIONAL
  }
  ReducedMaxBW-FRx-r16 ::=  SEQUENCE {
    reducedBW-DL-r16  ReducedAggregatedBandwidth,
    reducedBW-UL-r16  ReducedAggregatedBandwidth
  }
```

ReducedAggregatedBandwidth::=ENUMERATED {nmhz0, mhz10, mhz20, mhz30, mhz40, mhz50, mhz60, mhz80, mhz100, mhz200, mhz300, mhz400}

| MinBW ::= | SEQUENCE { |
|---|---|
| minBW-DL | AggregatedBandwidth, |
| OPTIONAL | |
| minBW-UL | AggregatedBandwidth, |

OPTIONAL
}

AggregatedBandwidth::=ENUMERATED {mhz0, mhz10, mhz20, mhz30, mhz40, mhz50, mhz60, mhz80, mhz100, mhz200, mhz300, mhz400, mhz400, mhz800, mhz1200, mhz1600, mhz2000}

| MaxCC-Preference-r16 ::= | SEQUENCE { |
|---|---|
| reducedMaxCCs-r16 | ReducedMaxCCs-r16 |
| OPTIONAL | |
| } | |
| ReducedMaxCCs-r16 ::= | SEQUENCE { |
| reducedCCsDL-r16 | INTEGER (0..31), |
| reducedCCsUL-r16 | INTEGER (0..31) |
| } | |
| MinCC-Preference-r16 ::= | SEQUENCE { |
| minCCs | MinCCs |
| OPTIONAL | |
| } | |
| MinCC ::= | SEQUENCE { |
| minCCsDL | INTEGER (0..31), |
| minCCsUL | INTEGER (0..31) |

}

reducedBW-FR1: This field indicates the UE's preference on reduced configuration corresponding to the maximum aggregated bandwidth across all downlink carrier(s) and across all uplink carrier(s) of FR1, to address overheating or power saving. This field is allowed to be reported only when UE is configured with serving cell(s) operating on FR1. The aggregated bandwidth across all downlink carrier(s) of FR1 is the sum of bandwidth of active downlink BWP(s) across all activated downlink carrier(s) of FR1. The aggregated bandwidth across all uplink carrier(s) of FR1 is the sum of bandwidth of active uplink BWP(s) across all activated uplink carrier(s) of FR1. If the field is absent from the MaxBW-Preference IE or the OverheatingAssistance IE, it is interpreted as the UE having no preference on the maximum aggregated bandwidth of FR1. When indicated to address overheating, this maximum aggregated bandwidth includes carrier(s) of FR1 of both the NR MCG and the SCG. This maximum aggregated bandwidth only includes carriers of FR1 of the SCG in (NG)EN-DC. Value mhz0 is not used when indicated to address overheating. When indicated to address power saving, this maximum aggregated bandwidth includes carrier(s) of FR1 of the cell group that this UE assistance information is associated with. The aggregated bandwidth can only range up to the current active configuration when indicated to address power savings.

reducedBW-FR2: This field indicates the UE's preference on reduced configuration corresponding to the maximum aggregated bandwidth across all downlink carrier(s) and across all uplink carrier(s) of FR2-1, to address overheating or power saving. This field is allowed to be reported only when UE is configured with serving cell(s) operating on FR2-1. The aggregated bandwidth across all downlink carrier(s) of FR2-1 is the sum of bandwidth of active downlink BWP(s) across all activated downlink carrier(s) of FR2-1. The aggregated bandwidth across all uplink carrier(s) of FR2-1 is the sum of bandwidth of active uplink BWP(s) across all activated uplink carrier(s) of FR2-1. If the field is absent from the MaxBW-Preference IE or the OverheatingAssistance IE, it is interpreted as the UE having no preference on the maximum aggregated bandwidth of FR2-1. When indicated to address overheating, this maximum aggregated bandwidth includes carrier(s) of FR2-1 of both the NR MCG and the NR SCG. This maximum aggregated bandwidth only includes carriers of FR2-1 of the SCG in (NG)EN-DC. When indicated to address power saving, this maximum aggregated bandwidth includes carrier(s) of FR2-1 of the cell group that this UE assistance information is associated with. The aggregated bandwidth can only range up to the current active configuration when indicated to address power savings.

minBW: This field indicates the UE's preference on the increased aggregated bandwidth across all downlink secondary carrier(s) and across all uplink secondary carrier(s) of FR1 and FR2-1 and FR2-2. The aggregated bandwidth across all downlink carrier(s) is the sum of bandwidth of active downlink BWP(s) across all activated secondary downlink carrier(s). The aggregated bandwidth across all uplink carrier(s) is the sum of bandwidth of active uplink BWP(s) across all activated secondary uplink carrier(s). If the field is absent from the MinBW-Preference IE, it is interpreted as the UE having no preference on minimum aggregated bandwidth The aggregated bandwidth can only range up to the current configured/deactivated configuration (e.g. bandwidth of D1-SCells and D2-SCells).

reducedCCsDL: This field indicates the UE's preference on reduced configuration corresponding to the maximum number of downlink SCells indicated by the field, to address overheating or power saving. When indicated to address overheating, this maximum number includes both SCells of the NR MCG and PSCell/SCells of the SCG. This maximum number only includes PSCell/SCells of the SCG in (NG)EN-DC. When indicated to address power saving, this maximum number includes PSCell/SCells of the cell group that this UE assistance information is associated with. The maximum number of downlink SCells can only range up to the current active configuration when indicated to address power savings.

reducedCCsUL: This field indicates the UE's preference on reduced configuration corresponding to the maximum number of uplink SCells indicated by the field, to address overheating or power saving. When indicated to address overheating, this maximum number includes both SCells of the NR MCG and PSCell/SCells of the SCG. This maximum number only includes PSCell/SCells of the SCG in (NG)EN-DC. When indicated to address power saving, this maximum number includes PSCell/SCells of the cell group that this UE assistance information is associated with. The maximum number of uplink SCells can only range up to the current active configuration when indicated to address power savings.

minCCsDL: This field indicates the UE's preference on number of downlink SCells. This number includes both SCells of the NR MCG and PSCell/SCells of the SCG. This maximum number only includes PSCell/SCells of the SCG in (NG)EN-DC. The number of downlink SCells can only range up to the current configuration (e.g. configured SCells; PSCell, A-SCell(s), D1-SCell(s) and D2-SCell (s)).

minCCsUL: This field indicates the UE's preference on increased number of uplink SCells. This number includes both SCells of the NR MCG and PSCell/SCells of the SCG. This minimum number only includes PSCell/SCells of the SCG in (NG)EN-DC. The number of uplink SCells can only range up to the current configuration (e.g. configured SCells; A-SCell(s), D1-SCell(s) and D2-SCell (s)).

To request GNB to change the SCell status in such a way that available bandwidth for data transfer increases, UE performs Initiation_UEAssistanceInformation and Transmission_UEAssistanceInformation.

<Initiation_UEAssistaneceInformation>
if configured to provide its preference on the maximum aggregated bandwidth of a cell group for power saving and T346b is not running:
   if the UE has a preference on the maximum aggregated bandwidth of the cell group and the UE did not transmit a UEAssistanceInformation message with maxBW-Preference and/or maxBW-PreferenceFR2-2 for the cell group since it was configured to provide its preference on the maximum aggregated bandwidth of the cell group for power saving; or
   if the current maxBW-Preference information for the cell group is different from the one indicated in the last transmission of the UEAssistanceInformation message including maxBW-Preference and/or maxBW-PreferenceFR2-2for the cell group and timer T346b associated with the cell group is not running:
      start the timer T346b with the timer value set to the maxBW-PreferenceProhibitTimer of the cell group;
      initiate transmission of the UEAssistanceInformation message in accordance with 5.7.4.3 to provide the current maxBW-Preference and/or maxBW-PreferenceFR2-2;
if configured to provide its preference on the maximum number of secondary component carriers of a cell group for power saving and T346c is not running:
   if the UE has a preference on the maximum number of secondary component carriers of the cell group and the UE did not transmit a UEAssistanceInformation message with maxCC-Preference for the cell group since it was configured to provide its preference on the maximum number of secondary component carriers of the cell group for power saving; or
   if the current maxCC-Preference information for the cell group is different from the one indicated in the last transmission of the UEAssistanceInformation message including maxCC-Preference for the cell group and timer T346c associated with the cell group is not running:
      start the timer T346c with the timer value set to the maxCC-PreferenceProhibitTimer of the cell group;
      initiate transmission of the UEAssistanceInformation message in accordance with 5.7.4.3 to provide the current maxCC-Preference;
if configured to provide its preference on the minimum aggregated SCell bandwidth of a cell group for data boosting (higher data rate; bulk data transfer) and T346q is not running:
   if the UE has a preference on the aggregated SCell bandwidth of the cell group and the UE did not transmit a UEAssistanceInformation message with minBW-Preference for the cell group since it was configured to provide its preference on the maximum aggregated bandwidth of the cell group for power saving; or
   if the current minBW-Preference information for the cell group is different from the one indicated in the last transmission of the UEAssistanceInformation message including minBW-Preference for the cell group and timer T346q associated with the cell group is not running:
      start the timer T346q with the timer value set to the minBW-PreferenceProhibitTimer (indicated in RRCReconfiguration generated by the base station o the cell group) of the cell group;
      initiate transmission of the UEAssistanceInformation message in accordance with 5.7.4.3 to provide the current minBW-Preference;
if configured to provide its preference on the number of secondary component carriers of a cell group for data boosting and T346p is not running:
   if the UE has a preference on the number of secondary component carriers of the cell group and the UE did not transmit a UEAssistanceInformation message with MinCC-Preference for the cell group since it was configured to provide its preference on the number of secondary component carriers of the cell group for data boosting; or
   if the current MinCC-Preference information for the cell group is different from the one indicated in the last transmission of the UEAssistanceInformation message including MinCC-Preference for the cell group and timer T346r associated with the cell group is not running:
      start the timer T346p with the timer value set to the MinCC-PreferenceProhibitTimer (indicated in RRCReconfiguration generated by the base station o the cell group) of the cell group;
      initiate transmission of the UEAssistanceInformation message in accordance with 5.7.4.3 to provide the current MinCC-Preference;

<Transmission_UEAssistaneceInformation>
if transmission of the UEAssistanceInformation message is initiated to provide maxBW-Preference of a cell group for power saving:
   include maxBW-Preference in the UEAssistanceInformation message;
   if the UE has a preference on the maximum aggregated bandwidth for the cell group:
      if the UE prefers to reduce the maximum aggregated bandwidth of FR1:
         include reducedMaxBW-FR1 in the MaxBW-Preference IE;
         set reducedBW-DL to the maximum aggregated bandwidth the UE desires to have configured across all downlink carriers of FR1 in the cell group;
         set reducedBW-UL to the maximum aggregated bandwidth the UE desires to have configured across all uplink carriers of FR1 in the cell group;
      if the UE prefers to reduce the maximum aggregated bandwidth of FR2-1:
         include reducedMaxBW-FR2 in the MaxBW-Preference IE;
         set reducedBW-DL to the maximum aggregated bandwidth the UE desires to have configured across all downlink carriers of FR2-1 in the cell group;
         set reducedBW-UL to the maximum aggregated bandwidth the UE desires to have configured across all uplink carriers of FR2-1 in the cell group;
   else (if the UE has no preference on the maximum aggregated bandwidth for the cell group):
      do not include reducedMaxBW-FR1 and reducedMaxBW-FR2 in the MaxBW-Preference IE;
if transmission of the UEAssistanceInformation message is initiated to provide maxBW-PreferenceFR2-2 of a cell group for power saving:
   include maxBW-PreferenceFR2-2 in the UEAssistanceInformation message;
      if the UE prefers to reduce the maximum aggregated bandwidth of FR2-2:
         include reducedMaxBW-FR2-2 in the MaxBW-PreferenceFR2-2 IE;
         set reducedBW-FR2-2-DL to the maximum aggregated bandwidth the UE desires to have configured across all downlink carriers of FR2-2 in the cell group;
         set reducedBW-FR2-2-UL to the maximum aggregated bandwidth the UE desires to have configured across all uplink carriers of FR2-2 in the cell group;
   else (if the UE has no preference on the maximum aggregated bandwidth for the cell group):
      do not include reducedMaxBW-FR2-2 in the MaxBW-PreferenceFR2-2 IE;
if transmission of the UEAssistanceInformation message is initiated to provide minBW-Preference of a cell group for data boosting:
   include minBW-Preference in the UEAssistanceInformation message;
   if the UE has a preference on the aggregated bandwidth for the cell group:
      include MinBW in the minBW-Preference IE;
      set minBW-DL to the aggregated bandwidth the UE desires to have configured across all downlink secondary carriers of FR1 and FR2-1 and FR2-2 in the cell group;
      set minBW-UL to the aggregated bandwidth the UE desires to have configured across all uplink secondary carriers of FR1 and FR2-1 and FR2-2 in the cell group;
   else (if the UE has no preference on the aggregated bandwidth for the cell group):
      do not include minBW-DL and minBW-UL in the MinBW-Preference IE;
if transmission of the UEAssistanceInformation message is initiated to provide maxCC-Preference of a cell group for power saving:
   include maxCC-Preference in the UEAssistanceInformation message;
   if the UE has a preference on the maximum number of secondary component carriers for the cell group:
      include reducedMaxCCs in the MaxCC-Preference IE;
      set reducedCCsDL to the number of maximum SCells the UE desires to have configured in downlink in the cell group;
      set reducedCCsUL to the number of maximum SCells the UE desires to have configured in uplink in the cell group;
   else (if the UE has no preference on the maximum number of secondary component carriers for the cell group):
      do not include reducedMaxCCs in the MaxCC-Preference IE;
if transmission of the UEAssistanceInformation message is initiated to provide sccNR-Preference of a cell group for data boosting:
   include SecNR-Preference in the UEAssistanceInformation message;
   if the UE has a preference on the number of activated secondary component carriers for the cell group:
      include MinCC in the MinCC-Preference IE;
      set minCCsDL to the number of activated SCells the UE desires to have activated in downlink in the cell group;
      set minCCsUL to the number of activated SCells the UE desires to have activated in uplink in the cell group;
   else (if the UE has no preference on the number of activated secondary component carriers for the cell group):
      do not include minCC in the MinCC-Preference IE; The UE shall:
if the UE is in (NG)EN-DC:
   if SRB3 is configured and the SCG is not deactivated:
      submit the UEAssistanceInformation message via SRB3 to lower layers for transmission;
   else:
      submit the UEAssistanceInformation message via the E-UTRA MCG embedded in E-UTRA RRC message ULInformationTransferMRDC.
else if the UE is in NR-DC:
   if the UE assistance configuration that triggered this UE assistance information is associated with the SCG:
      if SRB3 is configured and the SCG is not deactivated:
         submit the UEAssistanceInformation message via SRB3 to lower layers for transmission;
      else:
         submit the UEAssistanceInformation message via the NR MCG embedded in NR RRC message ULInformationTransferMRDC;
   else:
      submit the UEAssistanceInformation message via SRB1 to lower layers for transmission;
else:
   submit the UEAssistanceInformation message to lower layers for transmission.

FIG. 3B illustrates the operation between the terminal and base station for UEAssistanceInformaiton for power saving or for data boosting.

UE and GNB perform data transfer via PCell and activated SCells 3B10.

UE determines that data boosting is required based on that data heavy application is initiated 3B20. UE may perform initiation_UEAssistanceInformation to determine whether to transmit UEAssistanceInformation. UE may perform transmission_UEAssistanceInformation if determined so.

UE transmits UEAssistanceInformation 3B30. The UEAssistanceInformation includes the preference on the minimum aggregated bandwidth of active BWP or minimum number of activated SCCs for data boosting.

GNB takes proper measures to accommodate the UE's preference for data boosting. GNB may transmits SSB_State_Indication to activate SSB transmission of SCells (e.g. to cause state transition from D2-SCell to D1-SCell) 3B40 and SCell A/D MAC CE to activated the SCells 3B50.

UE and GNB perform data transfer via PCell and activated SCells 3B60. Comparing to 3B10, the number of activated SCells and the total aggregated bandwidth of active BWP are increased.

UE determines that data boosting is not required based on that data heavy application is terminated 3B70. UE may perform initiation_UEAssistanceInformation to determine whether to transmit UEAssistanceInformation. UE may perform transmission_UEAssistanceInformation if determined so.

UE transmits UEAssistanceInformation 3B80. The UEAssistanceInformation includes MinBW-Preference IE that contains neither minBW-DL nor minBW-UL if the previous UEAssistanceInformation included MinBW-Preference IE. The UEAssistanceInformation includes SccNR-Preference IE that does not contain minCC if the previous UEAssistanceInformation included SccNR-Preference IE.

GNB takes proper measures to achieve network power saving. GNB may transmit SSB_State_Indication to deactivate SSB transmission of SCells (e.g. to cause state transition from D1-SCell/A-SCell to D2-SCell) 3B90.

UE determines that power saving is required based on that residual battery power is below a certain threshold 3B100. UE may perform initiation_UEAssistanceInformation to determine whether to transmit UEAssistanceInformation. UE may perform transmission_UEAssistanceInformation if determined so.

UE transmits UEAssistanceInformation 3B110. The UEAssistanceInformation includes the preference on the maximum aggregated bandwidth of active BWP or maximum number of SCCs for power saving.

GNB takes proper measures to accommodate the UE's preference. GNB may transmits RRCReconfiguration to reduce the aggregate bandwidth or number of SCCs 3B120.

For serving cell measurement, UE may perform followings.

At 4A10, UE receives an RRC message, wherein the RRC message comprises a serving cell configuration IE for a first serving cell.

At 4A20, UE performs measurement on synchronization signal of the first serving cell based on that:
the first serving cell is not a second type secondary cell [D2-SCell]; and a first field [servingCellMO] is comprised in the serving cell configuration IE.

At 4A30, UE performs measurement result report based on the measurement results on synchronization signal of the first serving cell.

The first field indicates a measurement object that is associated with the first serving cell.

The physical boradcast channel (PBCH) is:
periodically transmitted in a first type secondary cell; and not transmitted (or transmitted with a longer periodicity) in the second type secondary cell.

UE determines that the first serving cell is the second type secondary cell in case that:
a field indicating no PBCH transmission is comprised in the serving cell configuration IE; or
a downlink information indicating no PBCH transmission for the first serving cell is received.

For measurement reporting (and for applicable cell determination), UE may perform followings.

At 4B10, UE receives a RRC message, wherein the RRC message comprises:
a measurement configuration IE; and
a serving cell configuration IE for a first serving cell.

At 4B20, UE determines based on the measurement configuration IE that a first measurement identity is associated with:
a first measurement object; and
a first report configuration.

At 4B30, UE determines that the first serving cell is associated with the first measurement object based on that:
a first field [servingCellMO] is comprised in the serving cell configuration IE for the first serving cell; and
the first field indicates the identity of the first measurement object.

At 4B40, UE determines whether the first serving cell is applicable for the first measurement identity based on:
a type of an event associated with the first measurement identity; and
a type of the first serving cell.

At 4B50, UE determines whether the entry condition for the event is fulfilled based on layer 3 filtered measurements of a one or more applicable cells for the first measurement identity.

At 4B60, UE triggers measurement report for the first measurement identity based on that the entry condition for the event is fulfilled for the one or more applicable cells.

The first serving cell is applicable in case that:
the event associated with the first measurement identity is a first type; or
the event associated with the first measurement identity is a second type and the first serving cell is not second type secondary serving cell.

The first serving cell is not applicable in case that:
the event associated with the first measurement identity is the second type; and
the first serving cell is second type secondary serving cell; The first type event is an event related to only a specific serving cell.

The second type event is event related to a specific serving cell and a one or more neighbouring cells.

PBCH is periodically transmitted in a first type secondary cell.

PBCH is not transmitted in the second type secondary cell.

For a Synchronization Signal reception, UE may perform followings:

At 4C10, UE receives a RRC message, wherein the RRC message comprises a serving cell configuration IE for a first serving cell;

At 4C20, UE receives, in a downlink channel of a second serving cell [PCell], a control information based on a first RNTI and a common search space.

At 4C30, UE determines, based on a specific bit of the control information, whether to:
perform measurement on a synchronization signal of the first serving cell;
consider the layer 3 filtered measurement results of the SS of the first serving cell to determine whether to trigger measurement report; and
include the layer 3 filtered measurement results of the first serving cell in the measurement report; At 4C40, UE performs measurement report procedure based on the determination.

The control information comprises one or more bits.

Each of the one or more bits is associated with a cell.

The association between the specific bit and the first serving cell is indicated in the RRC message.

UE performs measurement on the SS of the first serving cell in case that:
the specific bit of the control information is set to a first value; and
the SS of the first serving cell was not measured by the UE before the reception of the control information.

UE does not perform measurement on the SS of the first serving cell in case that:
the specific bit of the control information is set to a second value; and
the SS of the first serving cell was measured by the UE before the reception of the control information.

UE considers the layer 3 filtered measurement results of the SS of the first serving cell in triggering measurement report in case that:
the specific bit of the control information is set to a first value; and
the SS of the first serving cell was not measured by the UE before the reception of the control information.

UE does not consider the layer 3 filtered measurement results of the SS of the first serving cell in triggering measurement report in case that:
the specific bit of the control information is set to a second value; and
the SS of the first serving cell was measured by the UE before the reception of the control information.

UE includes the layer 3 filtered measurement results of the first serving cell in the measurement report in case that:
the specific bit of the control information is set to a first value; and
the SS of the first serving cell was not measured by the UE before the reception of the control information.

UE does not include the layer 3 filtered measurement results of the first serving cell in the measurement report in case that:
the specific bit of the control information is set to a second value; and
the SS of the first serving cell was measured by the UE before the reception of the control information.

UE performs followings:
receiving a radio resource control (RRC) message, wherein the RRC message comprises a set of configuration parameters for a secondary cell (Scell); and
starting a measurement on the SCell:
   at a first time point in case that the SCell is a first type SCell or a second type SCell; and
   at a second time point in case that the SCell is a third type SCell,
wherein the SCell is the first type SCell in case that the set of configuration parameters for the SCell:
   comprises a first parameter [SCell state]; and
   does not comprise a second parameter [SSB_OFF_INDICATION],
wherein the SCell is the second type SCell in case that the set of configuration parameters for the SCell:
   does not comprise the first parameter; and
   does not comprise the second parameter,
wherein the SCell is the third type SCell in case that the set of configuration parameters for the SCell:
   does not comprise the first parameter; and
   comprises the second parameter,
wherein:
   the first time point is determined based on time point when the RRC message is received; and
   the second time point is determined based on time point when a specific downlink information is received,
   wherein:
      the specific downlink information comprises one or more bits; and
      a specific bit of the one or more bits corresponds to the SCell.

The first parameter is related to state of corresponding cell; and

The second parameter is related to transmission of a first set of downlink signals [PSS/SSS/PBCH] of corresponding cell.

The measurement on the SCell is performed based on discontinuous reception period in case that the SCell is the first type SCell; and

The measurement on the SCell is performed based on a measurement cycle in case that the SCell is the second type SCell.

The measurement cycle is determined based on a measurement cycle parameter; and

The measurement cycle parameter is determined based on a third parameter [servingCellMO] in the set of configuration parameters for the SCell.

The third parameter comprises an identifier;

The identifier indicates a set of measurement parameters; and

The set of measurement parameters comprises the measurement cycle parameter.
The measurement on the SCell is performed on a second set of downlink signals [PSS/SSS];
The second set of downlink signals comprises a first synchronization signal and a second synchronization signal; and
The first set of downlink signals comprises the second set of downlink signals and a downlink signal on physical broadcast channel.
The first synchronization signal is transmitted in a first symbol;
The second synchronization signal is transmitted in a second symbol; and
The first symbol and the second symbol are apart by an interval of a symbol.

UE may perform followings based on SCell measurement:
initiating a measurement reporting procedure; and
transmitting a measurement report message.

The measurement report message comprises a parameter for measurement results on the SCell in case that:
the SCell is the first type SCell or the second type SCell; and
a third parameter is comprised in the set of configuration parameters for the SCell.

The measurement report message does not comprise the parameter for measurement results on the SCell in case that the SCell is the third type SCell.

The third parameter indicates a set of measurement parameters associated with the SCell.

The second time point is further determined based on a specific subcarrier spacing;

The specific subcarrier spacing is subcarrier spacing of a first cell; and

The first cell is not the Scell.

The second time point is further determined based on a slot where hybrid automatic retransmission request acknowledgement for the downlink control information is transmitted [D2-Scell→A-Scell].

For SCell type change, UE may perform followings:

At 4D10, UE receives a control message of a first layer [RRCReconfiguration], wherein the control message of the first layer comprises a serving cell configuration IE for a first serving cell.

At 4D20, UE determines a status of the first serving cell based on the control message of the first layer.

At 4D30, UE receives a control message of a second layer [SCell A/D MAC CE], wherein the control message of the second layer is related to a one or more secondary cells.

At 4D40, UE determines the status of the first serving cell based on the control message of the second layer.

At 4D50, UE receives a control message of a third layer [DCI 2_10], wherein the control message of the third layer is related to a one or more cells.

At 4D60, UE determines the status of the first serving cell based on the control message of the third layer.

The first serving cell is in a first state [A-SCell] in case that:
a first field [SCellState] is present in the serving cell configuration IE for the first serving cell in the control message of the first layer; or
a first specific bit of the control message of the second layer is set to a first value.

The first serving cell is in a second state [D1-SCell] in case that:
neither the first field [SCellState] nor a second field [SSB_OFF_INDICATION] is present in the serving cell configuration IE for the first serving cell in the control message of the first layer;
the first specific bit of the control message of the second layer is set to a second value; or
a second specific bit of the control message of the third layer is set to a third value.

The first serving cell is in a third state [D2-SCell] in case that:
the second field is present in the serving cell configuration IE for the first serving cell in the control message of the first layer; or
a second specific bit of the control message of the third layer is set to a fourth value.

The association between the first serving cell and the first specific bit of the control message of the second layer is determined based on a third field in the serving cell configuration IE of the first serving cell, wherein the third field comprises an identifier of the first serving cell; and
The association between the first serving cell and the second specific bit of the control message of the third layer is determined based on a fourth field [positionInDCI] in the serving cell configuration IE of the first serving cell, wherein the fourth field comprises an integer representing the position of the second specific bit in the control message of the third layer.

The control message of the first layer is generated by the first layer and comprehended by the first layer;
The control message of the second layer is generated by the third layer and comprehended by the second layer; and
The control message of the third layer is generated by the third layer and comprehended by the third layer.

The first layer is RRC layer;
The second layer is MAC layer; and
The third layer is PHY layer.

For PDCCH monitoring, UE may perform followings:
receiving, from a base station, a RRC message, wherein the RRC message comprises:
   a first IE comprising configuration parameters of a PCell;
   a second IE comprising configuration parameters of a first SCell;
   a third IE comprising configuration parameter of a second SCell; and
   a fourth IE comprising common configuration parameters for the PCell and the first SCell and the second SCell;
monitoring PDCCHs to receive a first DCI or a second DCI; and
performing relevant operations based on the first DCI or the second DCI,
wherein, to receive the first DCI:
   UE monitors a first Search Space of a specific cell based on a first RNTI;
   configuration parameters of the first SS are comprised in the first IE;
   the first SS is a common SS;
   the first RNTI is indicated in the fourth IE; and
   the specific cell is PCell,
wherein, to receive the second DCI:
   UE monitors a one or more second SSs of a one or more cells on a second RNTI;
   configuration parameters of the one or more second SSs are comprised in the first IE and the second IE and the third IE;
   the second SS is a UE specific SS;
   the second RNTI is indicated in the first IE;
   the one or more cells are the PCell and a one or more SCells; and
   the one or more SCells is either the first SCell or the second SCell or both,
wherein, in response to receiving the first DCI that comprises a first specific bit set to zero, UE stops for the first SCell a first set of actions and a second set of actions;
wherein, in response to receiving the first DCI that comprises the first specific bit set to one, UE stops for the first SCell the first set of actions and continues to perform the second set of actions;
wherein, in response to receiving based on a control message [SCell A/D MAC CE] that comprises a second specific bit set to zero, UE stops for the first SCell the first set of actions and continues to perform the second set of actions;
wherein, in response to receiving based on the control message that comprises the second specific bit set to one, the UE starts for the first SCell the first set of actions and the second set of actions;
wherein:
   the first set of actions relates to scheduling; and
   the second set of actions relates to layer 3 measurement;
wherein:
   the association between the first specific bit and the first SCell is derived based on a IE indicating the position of the first specific bit; and
   the association between the second specific bit and the first SCell is derived based on a IE indicating the index of the first SCell.

For BFR, UE may perform followings:
receiving, from a base station, a RRC message, wherein the RRC message comprises:
   a first IE comprising configuration parameters of a PCell;
   a second IE comprising configuration parameters of a first SCell;
   a third IE comprising configuration parameter of a second SCell; and
   a fourth IE comprising common configuration parameters for the PCell and the first SCell and the second SCell;
receiving, from the base station and based on the fourth IE, a DCI, wherein the DCI comprises:
   a first bit associated with the first SCell; and
   a second bit associated with the second SCell;
   performing a first set of operations in case that the first bit is set to a first value,
wherein the first set of operation comprises:
   cancelling all triggered BFRs for the first SCell at a first point of time; and
   stopping CSI reporting for the first SCell at a second point of time,
wherein the first point of time is determined based on SCS of a specific downlink BWP of the first SCell,
wherein the second point of time is determined based on SCS of a specific uplink BWP of the PCell,
wherein the association between the first bit and the first SCell is indicated in the second IE,
wherein the association between the second bit and the second SCell is indicated in the third IE.

For CSI reporting, UE may perform followings:
receiving, from a base station, a RRC message, wherein the RRC message comprises:
   a first IE comprising configuration parameters of a PCell;
   a second IE comprising configuration parameters of a first SCell;
performing CSI reporting for the first SCell based on the first IE and the second IE;
determining to deactivate the first SCell; and
stopping CSI reporting for the first SCell at a specific time point,
wherein, in case that the first SCell is deactivated based on a DCI, the specific time point is determined based on:
   slot number of downlink slot when the DCI is received;
   SCS of a specific uplink BWP of the PCell; and
   a first coefficient;
wherein, in case that the first SCell is deactivated based on a SCell A/D MAC CE, the specific time point is determined based on:
   slot number of uplink slot when HARQ ACK for the SCell A/D MAC CE is transmitted; and
   SCS of the specific uplink BWP of the PCell; and
   a second coefficient;
wherein, in case that the first SCell is deactivated based on a expriy of deactivation timer, the specific time point is determined based on:
   slot number of slot when the deactivation timer expires; and
   SCS of a specific downlink BWP of the first SCell; and
   the second coefficient.

To request increased availability of SCCs, UE may perform followings:
determining to provide preference on availability of SCCs in case that:
   UE has a preference on availability of SCCs of a cell group;
   a prohibit timer is not running; and
   the preference on availability of SCCs of the cell group is different from a preference on availability of SCCs indicated last time;
transmitting to the base station a first uplink message, wherein the first uplink message comprises a first field that indicates a specific downlink bandwidth,
wherein the first specific downlink bandwidth is determined based on the one or more available SCCs and one or more unavailable SCCs,
wherein the available SCC is a first type SCC,
wherein the unavailable SCC is either a second type SCC or a third type SCC,
wherein:
   the first type SCC is activated SCC;
   the second type SCC is deactivated SCC with SSB transmission; and
   the third type SCC is deactivated SCC without SSB transmission.

To request change of SCC state, UE may perform followings:
determining, by the terminal, to initiate transmission of a specific RRC message either for a first purpose or for a second purpose;
determining, by the terminal, a preference on:
   the maximum number of SCCs in case that the transmission of the specific RRC message is initiated for the first purpose; and
   the minimum number of SCCs in case that the transmission of the specific RRC message is initiated for the second purpose; and
transmitting, by the terminal, the specific RRC message, wherein the specific RRC message comprises a piece of information related to the preference,
wherein the first purpose is related to power saving, and
wherein the second purpose is related to enabling SSB transmission of one or more specific SCells (or related to data boosting; data transmission; higher data rate; data transfer),
wherein each of the one or more specific SCells is deactivated SCell without SSB transmission.

To request available bandwidth, UE may perform followings:
determining, by the terminal, to initiate transmission of a specific RRC message either for a first purpose or for a second purpose;
determining, by the terminal, a one or more pieces of information regarding aggregated bandwidth; and
transmitting, by the terminal, the specific RRC message, wherein the specific RRC message comprises the one or more pieces of information regarding aggregated bandwidth, and
wherein, in case that the transmission of the specific RRC message is initiated for the first purpose, a first piece of information and a second piece of information are comprised in the specific RRC message,
wherein, in case that the transmission of the specific RRC message is initiated for the second purpose, a third piece of information is comprised in the specific RRC message,
wherein:
   the first piece of information indicates preference related to the aggregated bandwidth across all downlink carriers of a first Frequency Region (FR);
   the second piece of information indicates preference related to the aggregated bandwidth across all downlink carriers of a second FR; and
   the third piece of information indicates preference related to the aggregated bandwidth across all downlink carriers of the first FR and the second FR,
wherein the second purpose is related to enabling SSB transmission of one or more specific SCells (or related to data boosting; data transmission; higher data rate; data transfer),
wherein each of the one or more specific SCells is deactivated SCell without SSB transmission.

For beam failure recovery, UE may perform followings:
receiving from a base station a radio resource control (RRC) message, wherein the RRC message comprises a set of configuration parameters for a secondary cell (SCell);
receiving from the base station a set of bits in a downlink message [DCI], wherein:
   a specific bit of the set of bits sets to a first value; and
   the specific bit corresponds to the SCell;
setting a beam failure indication counter of the SCell to a specific value;
cancelling all triggered beam failure recoveries of the SCell;
stopping a layer 1 measurement reporting [CSI on PUCCH] for the SCell;
removing the SCell from a list for layer 3 measurement [CellsTriggeredList];
receiving from the base station a second set of bits in a second downlink message [A/D MAC CE], wherein:
   a second specific bit of the second set of bits sets to a second value; and
   the second specific bit corresponds to the SCell;
starting the layer 1 measurement reporting for the SCell; and
triggering a layer 3 measurement reporting in case that the SCell is included in the list for layer 3 measurement.

The beam failure counter of the SCell increments by one in case that beam failure is detected for the SCell;

The beam failure recovery is triggered in case that the beam failure counter is equal to a maximum count; and

The maximum count is indicated in the set of configuration parameters for the SCell.

The beam failure counter of the SCell changes to the specific value in case that a specific timer expires or the downlink message with the specific bit set to the first value is received;

The specific timer [beamFailureDetectionTimer] starts in case that beam failure of the SCell is detected when the beam failure counter of the SCell is the specific value;
The specific timer restarts in case that beam failure of the SCell is detected when the beam failure counter of the SCell is greater than the specific value; and
The initial value of the specific timer is indicated in the set of configurtion parameters for the SCell.

The list for layer 3 measurement comprises one or more physical cell identities.

A physical cell identity of the SCell is included in the list for layer 3 measurement in case that entering condition is met for the SCell; and
A layer 3 measurement reporting is triggered in case that the physical cell identity of the SCell is included in the list for layer 3 measurement.

The second specific bit of the second set of bits in the second downlink message:
causes state transition of the SCell from a first state [Activated state] to a second state [deactivated state] in case that the second specific bit is set to the first value; and
causes state transition of the SCell from the second state to the first state in case that the second specific bit is set to the second vlaue.

The set of bits in the downlink message:
causes state transition of the SCell from the first state to a second state in case that the specific bit of the set of bits in the downlink message is set to the first value; and
does not cause state transition of the SCell from the second state to the first state in case that the specific bit of the set of bits in the downlink message is set to the second value.

Position of the specific bit in the set of bists is determined based on a first parameter [positionInDCI]; and

Position of the second specific bit in the second set of bits is determined based on a second parameter.

In case that the SCell is in the first state, the terminal does:
not transmit sounding reference signal (SRS) on the SCell;
not report channel state information (CSI) for the SCell;
not transmit on uplink-shared channel (UL-SCH) on the SCell;
not transmit on random access channel (RACH) on the SCell;
not monitor the physical downlink control channel (PDCCH) on the SCell;
not monitor the PDCCH for the SCell; and
not transmit physical uplink control channel (PUCCH) on the SCell.

In case that the SCell is in the second state, the terminal performs:
SRS transmissions on the SCell;
CSI reporting for the SCell;
PDCCH monitoring on the SCell;
PDCCH monitoring for the SCell; and
PUCCH transmissions on the SCell.

The layer 1 measurement reporting is performed on PUCCH.

The terminal generates a specific uplink control message in case that the beam failure recovery is triggered for the SCell.

The specific uplink control message comprises a specific number of bits;

Each bit of the specific number of bits corresponds to a serving cell; and

One of more candidate reference signal identifier fields.

Table 3 is ASN.1 of SCellConfig EE.

TABLE 3

| | |
|---|---|
| SCellConfig ::= | SEQUENCE { |
| sCellIndex | SCellIndex, |
| sCellConfigCommon | ServingCellConfigCommon |

OPTIONAL,

[symbol]

| | |
|---|---|
| sCellConfigDedicated | ServingCellConfig |

```
OPTIONAL, [symbol]
  ...,
  [[
```

| | |
|---|---|
| smtc | SSB-MTC |

OPTIONAL [symbol]
]],
[[

| | |
|---|---|
| sCellState-r16 | ENUMERATED {activated} |

OPTIONAL,

[symbol]

| | |
|---|---|
| secondaryDRX-GroupConfig-r16 | ENUMERATED {true} |

```
OPTIONAL Z,899;
  ]],
  [[
```

| | |
|---|---|
| preConfGapStatus-r17 | BIT STRING (SIZE (maxNrofGapId-r17)) |

OPTIONAL,

[symbol]

| | |
|---|---|
| goodServingCellEvaluationBFD-r17 | GoodServingCellEvaluation-r17 |

OPTIONAL,

[symbol]

| | |
|---|---|
| sCellSIB20-r17 | SetupRelease { SCellSIB20-r17 } |

OPTIONAL [symbol]
]]

| | |
|---|---|
| SSB_OFF_INDICATION | ENUMERATED {disabled} |

} [symbol]
indicates data missing or illegible when filed

sCellState field indicates whether the SCell shall be considered to be in activated state upon SCell configuration.

SSB_OFF_INDICATION field indicates whether the SSB transmission of SCell is disabled. If this field is absent, SSB transmission is enabled. If this field is present, SSB transmission is disabled.

Table 4 is ASN.1 of ServingCellConfig IE.

TABLE 4

| | |
|---|---|
| ServingCellConfig ::= | SEQUENCE { |
| tdd-UL-DL-ConfigurationDedicated | TDD-UL-DL-ConfigDedicated |

OPTIONAL,

[symbol]

| | |
|---|---|
| initialDownlinkBWB | BWP-DownlinkDedicated |

OPTIONAL,

[symbol]

| | |
|---|---|
| downlinkBWP-ToReleaseList | SEQUENCE (SIZE (1..maxNrofBWPs)) OF BWP-Id |

OPTIONAL,

[symbol]

| | |
|---|---|
| downlinkBWP-ToAddModList | SEQUENCE (SIZE (1..maxNrofBWPs)) OF BWP-Downlink |

OPTIONAL,

[symbol]

| | |
|---|---|
| firstActiveDownlinkBNP-Id | BWP-Id |

OPTIONAL,

[symbol]

| | |
|---|---|
| bwp-InactivityTimer | ENUMERATED {ms2, ms3, ms4, ms5, ms6, ms8, ms10, |

ms20, ms30,

ms40,ms50, ms60, ms80,ms100,

ms200,ms300, ms500,

ms750, ms1280, ms1920, ms2560, spare10,

spare9, spare8,

spare7, spare6, spare5, spare4, spare3,

spare2, spare1 } OPTIONAL,

[symbol]

| | |
|---|---|
| defaultDownlinkBWP-Id | BWP-Id |

OPTIONAL,

[symbol]

| | |
|---|---|
| uplinkConfig | UplinkConfig |

OPTIONAL,

[symbol]

| | |
|---|---|
| supplementaryUplink | UplinkConfig |

OPTIONAL,

[symbol]

| | |
|---|---|
| pdcch-ServingCellConfig | SetupRelease { PDCCH-ServingCellConfig } |

OPTIONAL,

[symbol]

| | |
|---|---|
| pdsch-ServingcellConfig | SetupRelease { PDSCH-ServingCellConfig } |

OPTIONAL,

[symbol]

| | |
|---|---|
| csi-MeasConfig | SetupRelease { CSI-MeasConfig } |

OPTIONAL,

[symbol]

| | |
|---|---|
| sCellDeactivationTimer | ENUMERATED {ms20, ms40, ms80, ms160, ms200, ms240, |
| | ms320, ms400, ms480, ms520, ms640, |

ms720,

ms840, ms1280, spare2, spare1}

OPTIONAL,

[symbol]

| | |
|---|---|
| crossCarrierSchedulingConfig | CrosscarrierSchedulingConfig |

OPTIONAL,

[symbol]

| | |
|---|---|
| tag-Id | TAG-ID, |
| dummy1 | ENUMERATED {enabled} |

OPTIONAL,

[symbol]

| | |
|---|---|
| pathlossReferenceLinking | ENUMERATED {spCell, scell} |

OPTIONAL,

[symbol]

| | |
|---|---|
| servingCellMO | MeasObjectId |

OPTIONAL, [symbol]
..., [symbol]
indicates data missing or illegible when filed

servingCellMO field indicates measObjectId of the MeasObjectNR in MeasConfig which is associated to the serving cell. Based on this field, UE determines measurement object to be measured for serving cell measurement.

Table 5 is ASN.1 of MeasConfig IE.

TABLE 5

| | |
|---|---|
| MeasConfig ::= | SEQUENCE { |
| measObjectToRemoveList | MeasObjectToRemoveList |

OPTIONAL,

[symbol]

| | |
|---|---|
| measObjectToAddModList | MeasObjectToAddModList |

OPTIONAL,

[symbol]

| | |
|---|---|
| reportConfigToRemoveList | ReportConfigToRemoveList |

OPTIONAL,

[symbol]

| | |
|---|---|
| reportConfigToAddModList | ReportConfigToAddModList |

OPTIONAL,

[symbol]

| | |
|---|---|
| measIdToRemoveList | MeasIdToRemoveList |

OPTIONAL,

[symbol]

| | |
|---|---|
| measIdToAddModList | MeasIdToAddModList |

OPTIONAL,

[symbol]

| | |
|---|---|
| s-MeasureConfig | CHOICE { |
| ssb-RSRP | RSRP-Range, |
| csi-RSRP | RSRP-Range |

}
OPTIONAL,

[symbol]

| | |
|---|---|
| quantityConfig | QuantityConfig |

OPTIONAL,

[symbol]

| | |
|---|---|
| measGapConfig | MeasGapConfig |

OPTIONAL,

[symbol]

| | |
|---|---|
| measGapSharingConfig | MeasGapSharingConfig |

```
OPTIONAL, [symbol]
  ...,
  [[
```

| | |
|---|---|
| interfrequencyConfig-NoGap-r16 | ENUMERATED {true} |

OPTIONAL, [symbol]
]]
}

| | |
|---|---|
| MeasObjectToRemoveList ::= | SEQUENCE (SIZE (1..maxNrofObjectId)) OF |

MeasObjectId

| | |
|---|---|
| MeasIdToRemoveList ::= | SEQUENCE (SIZE (1..maxNrofMeasId)) OF MeasId |
| ReportConfigToRemoveList ::= | SEQUENCE (SIZE (1..maxReportConfigId)) OF |

ReportConfigId

[symbol]

[symbol]

[symbol]

indicates data missing or illegible when filed

Table 6 is ASN.1 of MeasIdToAddModList IE.

TABLE 6

[symbol]

[symbol]

| | |
|---|---|
| MeasIdToAddModList ::= | SEQUENCE (SIZE (1..maxNrofMeasId)) OF MeasIdToAddMod |
| MeasIdToAddMod ::= | SEQUENCE { |
| measId | MeasId, |
| measObjectId | MeasObjectId, |
| reportConfigId | ReportConfigId |

}

[symbol]

[symbol]

[symbol]

indicates data missing or illegible when filed

For measurement reporting, a list of measurement identities where each measurement identity links one measurement object with one reporting configuration. By configuring multiple measurement identities, it is possible to link more than one measurement object to the same reporting configuration, as well as to link more than one reporting configuration to the same measurement object. The measurement identity is also included in the measurement report that triggered the reporting, serving as a reference to the network. For conditional reconfiguration triggering, one measurement identity links to exactly one conditional reconfiguration trigger configuration. And up to 2 measurement identities can be linked to one conditional reconfiguration execution condition.

Table 7 is ASN.1 of MeasObjectToAddModList IE.

TABLE 7

[symbol]

[symbol]

| | |
|---|---|
| MeasObjectToAddModList ::= | SEQUENCE (SIZE (1..maxNrofObjectId)) OF |

MeasObjectToAddMod

| | |
|---|---|
| MeasObjectToAddMod ::= | SEQUENCE { |
| measObjectId | MeasObjectId, |
| measObject | CHOICE { |
| measObjectNR | MeasObjectNR, |

...,

| | |
|---|---|
| measObjectEUTRA | MeasObjectEUTRA, |
| measObjectUTRA-FDD-r16 | MeasObjectUTRA-FDD-r16 |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16 |

}
}

[symbol]

[symbol]

[symbol]

indicates data missing or illegible when filed

Measurement object is an objects on which the UE shall perform the measurements.

For intra-frequency and inter-frequency measurements a measurement object indicates the frequency/time location and subcarrier spacing of reference signals to be measured.

The measObjectId of the MO which corresponds to each serving cell is indicated by servingCellMO within the serving cell configuration.

Table 8 is ASN.1 of MeasObjectNR IE.

TABLE 8

[symbol]

[symbol]

| | |
|---|---|
| MeasObjectNR ::= | SEQUENCE { |
| ssbFrequency | ARFCN-ValueNR |

OPTIONAL,

[symbol]

| | |
|---|---|
| ssbSubcarrierSpacing | SubcarrierSpacing |

OPTIONAL,

[symbol]

| | |
|---|---|
| smtc1 | SSB-MTC |

OPTIONAL,

[symbol]

| | |
|---|---|
| smtc2 | SSB-MTC2 |

OPTIONAL,

[symbol]

| | |
|---|---|
| refFreqCSI-RS | ARFCN-ValueNR |

OPTIONAL,

[symbol]

| | |
|---|---|
| referenceSignalConfig | ReferenceSignalConfig, |
| absThreshSS-BlocksConsolidation | ThresholdNR |

OPTIONAL,

[symbol]

| | |
|---|---|
| absThreshCSI-RS-Consolidation | ThresholdNR |

OPTIONAL,

[symbol]

| | |
|---|---|
| nrofSS-BlocksToAverage | INTEGER (2..maxNrofSS-BlocksToAverage) |

OPTIONAL,

[symbol]

| | |
|---|---|
| nrofCSI-RS-ResourcesToAverage | INTEGER (2..maxNrofCSI-RS-ResourcesToAverage) |

OPTIONAL,

[symbol]

| | |
|---|---|
| quantityConfigIndex | INTEGER (1..maxNrofQuantityConfig), |
| offsetMO | Q-OffsetRangeList, |
| cellsToRemoveList | PCI-List |

OPTIONAL,

[symbol]

| | |
|---|---|
| cellsToAddModList | CellsToAddModList |

OPTIONAL,

[symbol]

| | |
|---|---|
| excludedCellsToRemoveList | PCI-RangeIndexList |

OPTIONAL,

[symbol]

| | |
|---|---|
| excludedCellsToAddModList | SEQUENCE (SIZE (1..maxNrofPCI-Ranges)) OF PCI- |

RangeElement OPTIONAL,

[symbol]

| | |
|---|---|
| allowedCellsToRemoveList | PCI-RangeIndexList |

OPTIONAL,

[symbol]

| | |
|---|---|
| allowedCellsToAddModList | SEQUENCE (SIZE (1..maxNrofPCI-Ranges)) OF PCI- |

```
RangeElement OPTIONAL, [symbol]
  ...,
  [[
```

| | |
|---|---|
| freqBandIndicatorNR | FreqBandIndicatorNR |

OPTIONAL,

[symbol]

| | |
|---|---|
| measCycleSCell | ENUMERATED {sf160, sf256, sf320, sf512, sf640, |

```
sf1024, sf1280} OPTIONAL, [symbol]
  ]],
  [[
```

| | |
|---|---|
| smtc3list-r16 | SSB-MTC3List-r16 |

OPTIONAL,

[symbol]

| | |
|---|---|
| rmtc-Config-r16 | SetupRelease {RMTC-Config-r16} |

OPTIONAL,

[symbol]

| | |
|---|---|
| t312-r16 | SetupRelease { T312-r16 } |

```
OPTIONAL, [symbol]
  ]],
  [[
...
```

| | |
|---|---|
| CellsToAddModList ::= | SEQUENCE (SIZE (1..maxNrofCellMeas)) OF CellsToAddMod |
| CellsToAddModListExt-v1710 ::= | SEQUENCE (SIZE (1..maxNrofCellMeas)) OF |

CellsToAddModExt-v1710

| | |
|---|---|
| CellsToAddMod ::= | SEQUENCE { |
| physCellId | PhysCellId; |
| cellIndividualOffset | Q-OffsetRangeList |

} [symbol]
indicates data missing or illegible when filed

allowedCellsToAddModList field indicates List of cells to add/modify in the allow-list of cells. It applies only to SSB resources.

allowedCellsToRemoveList field indicates List of cells to remove from the allow-list of cells.

excludedCellsToAddModListfieldindicates List of cells to add/modify in the exclude-list of cells.

excludedCellsToRemoveList field indicates List of cells to remove from the exclude-list of cells.

ssbFrequency field indicates the frequency of the SS associated to this MeasObjectNR.

Table 9 is ASN.1 ofReportConfigToAddModList IE.

TABLE 9

[symbol]

[symbol]

| | |
|---|---|
| ReportConfigToAddModList ::= | SEQUENCE (SIZE (1..maxReportConfigId)) OF |

ReportConfigToAddMod

| | |
|---|---|
| ReportConfigToAddMod ::= | SEQUENCE { |
| reportConfigId | ReportConfigId, |
| reportConfig | CHOICE { |
| reportConfigNR | ReportConfigNR, |

...,

| | |
|---|---|
| reportConfigInterRAT | ReportConfigInterRAT, |
| reportConfigNR-SL-r16 | ReportConfigNR-SL-r16 |

}
}

[symbol]

[symbol]

[symbol]

indicates data missing or illegible when filed

The IE ReportConfigNR specifies criteria for triggering of an NR measurement reporting event or of a CHO, CPA or CPC event orofan L2 U2N relay measurement reporting event. For events labelled AN with N equal to 1, 2 and so on, measurement reporting events and CHO, CPA or CPC events are based on cell measurement results, which can either be derived based on SSiPBCH block or CCSI-RS.

Event A1 refers to the event where Serving becomes better than absolute threshold;

Event A2 refers to the event where Serving becomes worse than absolute threshold;

Event A3 refers to the event where Neighbour becomes amount of offset better than PCell/PSCell;

Event A4 refers to the event where Neighbour becomes better than absolute threshold;

Event A5 refers to the event where PCell/PSCell becomes worse than absolute threshold1 AND Neighbour/SCell becomes better than another absolute threshold2;

Event A6 refers to the event where Neighbour becomes amount of offset better than SCell.

Table 10 is ASN.1 of ReportConfigNR IE.

TABLE 10

| | |
|---|---|
| ReportConfigNR ::= | SEQUENCE { |
| reportType | CHOICE { |
| periodical | PeriodicalReportConfig, |
| eventTriggered | EventTriggerConfig, |

...,

| | |
|---|---|
| reportCGI | ReportCGI, |
| reportSFTD | ReportSFTD-NR, |
| condTriggerConfig-r16 | CondTriggerConfig-r16, |
| cli-Periodical-r16 | CLI-PeriodicalReportConfig-r16, |
| cli-EventTriggered-r16 | CLI-EventTriggerConfig-r16, |
| rxTxPeriodical-r17 | RxTxPeriodical-r17 |

}
}

| | |
|---|---|
| EventTriggerConfig::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |

},

| | |
|---|---|
| eventA3 | SEQUENCE { |
| a3-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN, |

},

| | |
|---|---|
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |

},

| | |
|---|---|
| eventA6 | SEQUENCE { |
| a6-Offset | MeasTriggerQuantityOffset, |
| reportOnLeave | BOOLEAN, |
| hysteresis | Hysteresis, |
| timeToTrigger | TimeToTrigger, |
| useAllowedCellList | BOOLEAN |

```
    },
    ...,
    [[
```

| | |
|---|---|
| eventX1-r17 | SEQUENCE { |
| x1-Threshold1-Relay-r17 | SL-MeasTriggerQuantity-r16, |
| x1-Threshold2-r17 | MeasTriggerQuantity, |
| reportOnLeave-r17 | BOOLEAN, |
| hysteresis-r17 | Hysteresis, |
| timeToTrigger-r17 | TimeToTrigger, |
| useAllowedCellList-r17 | BOOLEAN |

},

| | |
|---|---|
| eventX2-r17 | SEQUENCE { |
| x2-Threshold-Relay-r17 | SL-MeasTriggerQuantity-r16, |
| reportOnLeave-r17 | BOOLEAN, |
| hysteresis-r17 | Hysteresis, |
| timeToTrigger-r17 | TimeToTrigger |

},

| | |
|---|---|
| eventD1-r17 | SEQUENCE { |
| distanceThreshFromReference1-r17 | INTEGER(1.. 65525), |
| distanceThreshFromReference2-r17 | INTEGER(1.. 65525); |
| referenceLocation1-r17 | ReferenceLocation-r17, |
| referenceLocation2-r17 | ReferenceLocation-r17 |
| reportOnLeave-r17 | BOOLEAN, |
| hysteresisLocation-r17 | HysteresisLocation-r17, |
| timeToTrigger-r17 | TimeToTrigger |

```
    }
    ]]
  },
```

| | |
|---|---|
| rsType | NR-RS-Type, |
| reportInterval | ReportInterval, |
| reportAmount | ENUMERATED {r1, r2, r4, r8, r16, r32, r64, |

infinity},

| | |
|---|---|
| reportQuantityCell | MeasReportQuantity, |
| maxReportCells | INTEGER (1..maxCellReport), |
| reportQuantityRS-Indexes | MeasReportQuantity |

OPTIONAL,

[symbol]

| | |
|---|---|
| maxNrofRS-IndexesToReport | INTEGER (1..maxNrofIndexesToReport) |

OPTIONAL,

[symbol]

| | |
|---|---|
| includeBeamMeasurements | BOOLEAN, |
| reportAddNeighMeas | ENUMERATED {setup} |

```
OPTIONAL, [symbol]
  ...,
  [[
```

| | |
|---|---|
| measRSSI-ReportConfig-r16 | MeasRSSI-ReportConfig-r16 |

OPTIONAL,

[symbol]

| | |
|---|---|
| useT312-r16 | BOOLEAN |

OPTIONAL,

[symbol]

| | |
|---|---|
| includeCommonLocationInfo-r16 | ENUMERATED {true} |

OPTIONAL,

[symbol]

| | |
|---|---|
| includeBT-Meas-r16 | SetupRelease {BT-NameList-r16} |

OPTIONAL,

[symbol]

| | |
|---|---|
| includeWLAN-Meas-r16 | SetupRelease {WLAN-NameList-r16} |

OPTIONAL,

[symbol]

| | |
|---|---|
| includeSensor-Meas-r16 | SetupRelease {Sensor-NameList-r16} |

```
OPTIONAL, [symbol]
  ]],
  [[
```

| | |
|---|---|
| coarseLocationRequest-r17 | ENUMERATED {true} |

OPTIONAL,

[symbol]

| | |
|---|---|
| reportQuantityRelay-r17 | SL-MeasReportQuantity-r16 |

OPTIONAL, [symbol]
]]
}

| | |
|---|---|
| MeasTriggerQuantity ::= | CHOICE { |
| rsrp | RSRP-Range, |
| rsrq | RSRQ-Range, |
| sinr | SINR-Range |

}

| | |
|---|---|
| MeasTriggerQuantityOffset ::= | CHOICE { |
| rsrp | INTEGER (−30..30), |
| rsrq | INTEGER (−30..30) |
| sinr | INTEGER (−30..30) |

}

| | |
|---|---|
| MeasReportQuantity ::= | SEQUENCE { |
| rsrp | BOOLEAN, |
| rsrq | BOOLEAN, |
| sinr | BOOLEAN |

} [symbol]
indicates data missing or illegible when filed

a3-Offset/a6-Offset field indicates Offset value(s) to be used in NR measurement report triggering condition for event a3/a6. The actual value is field value*0.5 dB.

aN-ThresholdM field indicates Threshold value associated to the selected trigger quantity (e.g. RSRP, RSRQ, SINR) per RS Type (e.g. SS/PBCH block, CSI-RS) to be used in NR measurement report triggering condition for event number aN.

eventId field comprises a Choice of NR event triggered reporting criteria.

maxNrofRS-IndexesToReport field indicates Max number of RS indexes to include in the measurement report for A1-A6 events.

maxReportCells field indicates Max number of non-serving cells to include in the measurement report.

reportOnLeave field indicates whether or not the UE shall initiate the measurement reporting procedure when the leaving condition is met for a cell in cellsTriggeredList.

reportQuantityCell field indicates the cell measurement quantities to be included in the measurement report.

reportQuantityRS-Indexes field indicates which measurement information per RS index the UE shall include in the measurement report.

timeToTrigger field indicates time during which specific criteria for the event needs to be met in order to trigger a measurement report.

useAllowedCellList field indicates whether only the cells included in the allow-list of the associated measObject are applicable.

For useT312 field, if value TRUE is configured, the UE shall use the timer T312 with the value t312 as specified in the corresponding measObjectNR. If value FALSE is configured, the timer T312 is considered as disabled. Network configures value TRUE only if reportType is set to eventTriggered.

xN-ThresholdM field indicates threshold value associated to the selected trigger quantity (e.g. RSRP, RSRQ, SINR) per RS Type (e.g. SS/PBCH block, CSI-RS) to be used in NR measurement report triggering condition for event xN. If multiple thresholds are defined for event number xN, the thresholds are differentiated by M. x1-Threshold1 and x2-Threshold indicates the threshold value for the serving L2 U2N Relay UE, x1-Threshold2 indicates the threshold value for the NR Cells.

The cellsTriggeredList serves as a mechanism for tracking cells that have met specific measurement event criteria. It is used by mobile terminals (UEs) to manage and report on cells that have triggered measurement events. Based on this list, UE prevent duplicate measurement report to be sent.

The cellsTriggeredList is managed per measId (measurement identity). UE includes into the list physical cell identity of the cell for which entering (entry) condition is met.

UE removes from the list physical cell identity of the cell:
for which leaving condition is met; and
that is included in the list.

UE removes from the list physical cell identity of the cell:
of which cell state changes from A-Scell/D1-SCell to D2-Scell; and
that is included in the list.

UE initiates the measurement reporting procedure in case that:
a cell is included in the list; or
a cell is removed from the list due to meeting leaving condition.

UE does not initiate the measurement reporting procedure upon change of the list (addition/removal) in case that the change is caused by cell state change.

The MeasurementReport message is used for the indication of measurement results.

The MeasurementReport message comprises MeasResults IE. The IE MeasResults covers measured results for intra-frequency, inter-frequency, inter-RAT mobility and measured results for NR sidelink communication/discovery.

Table 10 is ASN.1 of MeasResults IE.

MeasResultNR IE comprises following fields

TABLE 10

[symbol]

[symbol]

| | |
|---|---|
| MeasResults ::= | SEQUENCE { |
| measId | MeasId, |
| measResultServingMOList | MeasResultServMOList, |

-- contains measurement results of specific serving cells (e.g. PCell and specific SCells)

| | |
|---|---|
| measResultNeighCells | CHOICE { |
| measResultListNR | MeasResultListNR, |

...,

| measResultListEUTRA | MeasResultListEUTRA, | |
|---|---|---|
| measResultListUTRA-FDD-r16 | MeasResultListUTRA-FDD-r16, | |
| sl-MeasResultsCandRelay-r17 | [symbol] | [symbol] |

```

[symbol]

  }
OPTIONAL,
  ...,
  [[
```

| | |
|---|---|
| measResultServFreqListEUTRA-SCG | MeasResultServFreqListEUTRA-SCG |

OPTIONAL,

| | |
|---|---|
| measResultServFreqListNR-SCG | MeasResultServFreqListNR-SCG |

OPTIONAL,

| | |
|---|---|
| measResultSFTD-EUTRA | MeasResultSFTD-EUTRA |

OPTIONAL,

| | |
|---|---|
| measResultSFTD-NR | MeasResultCellSFTD-NR |

```
OPTIONAL
  ]],
    [[
```

| | |
|---|---|
| measResultCellListSFTD-NR | MeasResultCellListSFTD-NR |

```
OPTIONAL
  ]],
  [[
```

| | |
|---|---|
| measResultForRSSI-r16 | MeasResultForRSSI-r16 |

OPTIONAL,

| | |
|---|---|
| locationInfo-r16 | LocationInfo-r16 |

OPTIONAL,

| | |
|---|---|
| ul-PDCP-DelayValueResultList-r16 | UL-PDCP-DelayValueResultList-r16 |

OPTIONAL,

| | |
|---|---|
| measResultsSL-r16 | MeasResultsSL-r16 |

OPTIONAL,

| | |
|---|---|
| measResultCLI-r16 | MeasResultCLI-r16 |

```
OPTIONAL
  ]],
  [[
```

| | |
|---|---|
| measResultRxTxTimeDiff-r17 | MeasResultRxTxTimeDiffr-r17 |

OPTIONAL,

| | |
|---|---|
| sl-MeasResultServingRelay-r17 | OCTET STRING |

OPTIONAL,

[symbol]

| | |
|---|---|
| ul-PDCP-ExcessDelayResultList-r17 | UL-PDCP-ExcessDelayResultList-r17 |

OPTIONAL,

| | |
|---|---|
| coarseLocationInfo-r17 | OCTET STRING |

OPTIONAL
]]
]

| | |
|---|---|
| MeasResultServMOList ::= | SEQUENCE (SIZE (1..maxNrofServingCells)) OF |

MeasResultServMO

| MeasResultServMO ::= | SEQUENCE { |
|---|---|
| servCellId | ServCellIndex, |
| measResultServingCell | MeasResultNR, |
| measResultBestNeighCell | MeasResultNR |

OPTIONAL,
...
]

| MeasResultListNR ::= | SEQUENCE (SIZE (1..maxCellReport)) OF MeasResultNR |
|---|---|
| MeasResultNR ::= | SEQUENCE { |
| physCellId | PhysCellId |

OPTIONAL,

| measResult | SEQUENCE { |
|---|---|
| cellResults | SEQUENCE { |
| resultsSSB-Cell | MeasQuantityResults |

OPTIONAL,

| | |
|---|---|
| resultsCSI-RS-Cell | MeasQuantityResults |

OPTIONAL
},

| rsIndexResults | SEQUENCE { |
|---|---|
| resultsSSB-Indexes | ResultsPerSSB-IndexList |

OPTIONAL,

| | |
|---|---|
| resultsCSI-RS-Indexes | ResultsPerCSI-RS-IndexList |

```
OPTIONAL
    }
OPTIONAL
  },
  ...,
  [[
```

| | |
|---|---|
| cgi-Info | CGI-InfoNR |

```
OPTIONAL
  ]] ,
  [[
```

| | |
|---|---|
| choCandidate-r17 | ENUMERATED {true} |

OPTIONAL,

| choConfig-r17 | SEQUENCE (SIZE (1..2)) OF CondTriggerConfig- |
|---|---|
| r16 | OPTIONAL, |
| triggeredEvent-r17 | SEQUENCE { |
| timeBetweenEvents-r17 | TimeBetweenEvent-r17 |

OPTIONAL,

| firstTriggeredEvent | ENUMERATED (condFirstEvent, |
|---|---|
| condSecondEvent) | OPTIONAL |

```
    }
OPTIONAL
  ]]
}
```

| | |
|---|---|
| MeasResultListEUTRA ::= | SEQUENCE (SIZE (1..maxCellReport)) OF |

MeasResultEUTRA

| MeasResultEUTRA ::= | SEQUENCE { |
|---|---|
| eutraPhysCellId; | PhysCellId, |
| measResult | MeasQuantityResultsEUTRA, |
| cgi-Info | CGI-InfoEUTRA |

OPTIONAL,
...
}

| | |
|---|---|
| MultiBandInfoListEUTRA ::= | SEQUENCE (SIZE (1..maxMultiBands)) OF |

FreqBandIndicatorEUTRA

| MeasQuantityResults ::= | SEQUENCE { |
|---|---|
| rsrp | RSRP-Range |

OPTIONAL,

| | |
|---|---|
| rsrq | RSRQ-Range |

OPTIONAL,

| | |
|---|---|
| sinr | SINR-Range |

OPTIONAL
}

| MeasQuantityResultsEUTRA ::= | SEQUENCE { |
|---|---|
| rsrp | RSRP-RangeEUTRA |

OPTIONAL,

| | |
|---|---|
| rsrq | RSRQ-RangeEUTRA |

OPTIONAL,

| | |
|---|---|
| sinr | SINR-RangeEUTRA |

OPTIONAL
}

| | |
|---|---|
| ResultsPerSSB-IndexList::= | SEQUENCE (SIZE (1..maxNrofIndexesToReport2)) OF |

ResultsPerSSB-Index

| ResultsPerSSB-Index ::= | SEQUENCE { |
|---|---|
| ssb-Index | SSB-Index, |
| ssb-Results | MeasQuantityResults |

OPTIONAL
}

| | |
|---|---|
| ResultsPerCSI-RS-IndexList::= | SEQUENCE (SIZE (1..maxNrofIndexesToReport2)) OF |

ResultsPerCSI-RS-Index

| ResultsPerCSI-RS-Index ::= | SEQUENCE { |
|---|---|
| csi-RS-Index | CSI-RS-Index, |
| csi-RS-Results | MeasQuantityResults |

OPTIONAL
}
MeasResultServFreqListEUTRA-SCG ::= SEQUENCE (SIZE (1..maxNrofServingCellsEUTRA)) OF
MeasResult2EUTRA
MeasResultServFreqListNR-SCG ::= SEQUENCE (SIZE (1..maxNrofServingCells)) OF MeasResult2NR

| | |
|---|---|
| MeasResultListUTRA-FDD-r16 ::= | SEQUENCE (SIZE (1..maxCellReport)) OF |

MeasResultUTRA-FDD-r16

| MeasResultUTRA-FDD-r16 ::= | SEQUENCE { | |
|---|---|---|
| physCellId-r16 | PhysCellIdUTRA-FDD-r16, | |
| measResult-r16 | SEQUENCE { | |
| utra-FDD-RSCP-r16 | INTEGER (−5..91) | OPTIONAL, |
| utra-FDD-EcN0-r16 | INTEGER (0..49) | OPTIONAL |

}
}

| | |
|---|---|
| MeasResultForRSSI-r16 ::= | SEQUENCE { |
| rssi-Result-r16 | RSSI-Range-r16, |
| channelOccupancy-r16 | INTEGER (0..100) |

}

| MeasResultCLI-r16 ::= | SEQUENCE { |
|---|---|
| measResultListSRS-RSRP-r16 | MeasResultListSRS-RSRP-r16 |

OPTIONAL,

| | |
|---|---|
| measResultListCLI-RSSI-r16 | MeasResultListCLI-RSSI-r16 |

OPTIONAL
}

| | |
|---|---|
| MeasResultListSRS-RSRP-r16 ::= | SEQUENCE (SIZE (1.. maxCLI-Report-r16)) OF MeasResultSRS- |

RSRP-r16

| | |
|---|---|
| MeasResultSRS-RSRP-r16 | SEQUENCE { |
| srs-ResourceId-r16 | SRS-ResourceId, |
| srs-RSRP-Result-r16 | SRS-RSRP-Range-r16 |

}

| | |
|---|---|
| MeasResultListCLI-RSSI-r16 ::= | SEQUENCE (SIZE (1.. maxCLI-Report-r16)) OF MeasResultCLI- |

RSSI-r16

| | |
|---|---|
| MeasResultCLI-RSSI-r16 ::= | SEQUENCE { |
| rssi-ResourceId-r16 | RSSI-ResourceId-r16, |
| cli-RSSI-Result-r16 | CLI-RSSI-Range-r16 |

}
UL-PDCP-DelayValueResultList-r16 ::= SEQUENCE (SIZE (1..maxDRB)) OF UL-PDCP-
DelayValueResult-r16
UL-PDCP-DelayValueResult-r16 ::= SEQUENCE {

| | |
|---|---|
| drb-Id-r16 | DRB-Identity, |
| averageDelay-r16 | INTEGER (0..10000), |

...
}
UL-PDCP-ExcessDelayResultList-r17 ::= SEQUENCE (SIZE (1..maxDRB)) OF UL-PDCP-
ExcessDelayResult-r17
UL-PDCP-ExcessDelayResult-r17 ::= SEQUENCE {

| | |
|---|---|
| drb-Id-r17 | DRB-Identity, |
| excessDelay-r17 | INTEGER (0..31), |

...
}
TimeBetweenEvent-r17 ::= INTEGER (0..1023)

[symbol]

-- ASN1STOP [symbol]
indicates data missing or illegible when filed

cellResults field indicates cell level measurement results.

locationInfo field indicates positioning related information and measurements.

physCellId field indicates the physical cell identity of the NR cell for which the reporting is being performed.

resultsSSB-Cell field indicates cell level measurement results based on SS/PBCH related measurements.

resultsSSB-Indexes field indicates beam level measurement results based on SS/PBCH related measurements.

resultsCSI-RS-Cell field indicates cell level measurement results based on CSI-RS related measurements.

resultsCSI-RS-Indexes field indicates beam level measurement results based on CSI-RS related measurements.

rsIndexResults field indicates beam level measurement results.

coarseLocationInfo field indicates the coarse location information reported by the UE.

measId field indicates identifies the measurement identity for which the reporting is being performed.

measQuantityResults field indicates the measurement result.

measResultListEUTRA field comprises list of measured results for the maximum number of reported best cells for an E-UTRA measurement identity.

measResultListNR field comprises list of measured results for the maximum number of reported best cells for an NR measurement identity.

measResultListUTRA-FDD field comprises list of measured results for the maximum number of reported best cells for a UTRA-FDD measurement identity.

measResultNR field comprises measured results of an NR cell.

measResultServingMOList field comprises measured results of measured cells with reference signals indicated in the serving cell measurement objects. This field includes measurement results of SpCell, configured SCell(s) and best neighbouring cell.

SS reference signal received power (SS-RSRP) is defined as the linear average over the power contributions (in [W]) of the resource elements that carry secondary synchronization signals. The measurement time resource(s) for SS-RSRP are confined within SS/PBCH Block Measurement Time Configuration (SMTC) window duration.

For SS-RSRP determination demodulation reference signals for physical broadcast channel (PBCH) and, if indicated by higher layers, CSI reference signals in addition to secondary synchronization signals may be used. SS-RSRP using demodulation reference signal for PBCH or CSI reference signal shall be measured by linear averaging over the power contributions of the resource elements that carry corresponding reference signals taking into account power scaling for the reference signals. If SS-RSRP is not used for L1-RSRP, the additional use of CSI reference signals for SS-RSRP determination is not applicable.

SS-RSRP shall be measured only among the reference signals corresponding to SS/PBCH blocks with the same SS/PBCH block index and the same physical-layer cell identity.

If SS-RSRP is not used for L1-RSRP and higher-layers indicate certain SS/PBCH blocks for performing SS-RSRP measurements, then SS-RSRP is measured only from the indicated set of SS/PBCH block(s).

A Serving Cell may be configured with one or multiple BWPs. The BWP switching for a Serving Cell is used to activate an inactive BWP and deactivate an active BWP at a time. The BWP switching is controlled by the PDCCH indicating a downlink assignment or an uplink grant, by the bwp-InactivityTimer, by RRC signalling, or by the UE itself upon initiation of Random Access procedure or upon detection of consistent LBT failure on SpCell. Upon RRC (re-)configuration of firstActiveDownlinkBWP-Id and/or firstActiveUplinkBWP-Id for SpCell except for PSCell when SCG is deactivated or activation of an SCell, the DL BWP and/or UL BWP indicated by firstActiveDownlinkBWP-Id and/or firstActiveUplinkBWP-Id respectively is active without receiving PDCCH indicating a downlink assignment or an uplink grant. Upon RRC (re-)configuration of firstActiveDownlinkBWP-Id for PSCell when SCG is deactivated, the DL BWP is switched to the firstActiveDownlinkBWP-Id. The active BWP for a Serving Cell is indicated by either RRC or PDCCH. For unpaired spectrum, a DL BWP is paired with a UL BWP, and BWP switching is common for both UL and DL.

For each activated Serving Cell configured with a BWP, the UE shall:
if a BWP is activated and the active DL BWP for the Serving Cell is not the dormant BWP and the Serving Cell is not the PSCell of deactivated SCG:
   transmit on UL-SCH on the BWP;
   transmit on RACH on the BWP, if PRACH occasions are configured;
   monitor the PDCCH on the BWP;
   transmit PUCCH on the BWP, if configured;
   report CSI for the BWP;
   transmit SRS on the BWP, if configured;
   receive DL-SCH on the BWP;
   (re-)initialize any suspended configured uplink grants of configured grant Type 1 on the active BWP according to the stored configuration, if any, and to start in the symbol according to predefined rules;
   if lbt-FailureRecoveryConfig is configured:
      stop the lbt-FailureDetectionTimer, if running;
      set LBT_COUNTER to 0;
      monitor LBT failure indications from lower layers.
if a BWP is activated and the active DL BWP for the Serving Cell is dormant BWP:
   stop the bwp-InactivityTimer of this Serving Cell, if running.
   not monitor the PDCCH on the BWP;
   not monitor the PDCCH for the BWP;
   not receive DL-SCH on the BWP;
   not report CSI on the BWP, report CSI except aperiodic CSI for the BWP;
   not transmit SRS on the BWP;
   not transmit on UL-SCH on the BWP;
   not transmit on RACH on the BWP;
   not transmit PUCCH on the BWP;
   clear any configured downlink assignment and any configured uplink grant Type 2 associated with the SCell respectively;
   suspend any configured uplink grant Type 1 associated with the SCell;
   if configured, perform beam failure detection and beam failure recovery for the SCell if beam failure is detected.
if a BWP is deactivated or the Serving Cell is PSCell of deactivated SCG:
   not transmit on UL-SCH on the BWP;
   not transmit on RACH on the BWP;
   not monitor the PDCCH on the BWP;
   not transmit PUCCH on the BWP;
   not report CSI for the BWP;
   not transmit SRS on the BWP;
   not receive DL-SCH on the BWP;
   clear any configured downlink assignment and configured uplink grant of configured grant Type 2 on the BWP;
   suspend any configured uplink grant of configured grant Type 1 on the inactive BWP.

Upon initiation of the Random Access procedure on a Serving Cell, after the selection of carrier for performing Random Access procedure, the UE shall for the selected carrier of this Serving Cell:
if PRACH occasions are not configured for the active UL BWP:
   if the UE is a RedCap UE; and
   if initialUplinkBWP-RedCap is configured:
      switch the active UL BWP to BWP indicated by initialUplinkBWP-RedCap.
   else:
      switch the active UL BWP to BWP indicated by initialUplinkBWP.
   if the Serving Cell is an SpCell:
      if the UE is a RedCap UE; and
      if initialDownlinkBWP-RedCap is configured:
         switch the active DL BWP to BWP indicated by initialDownlinkBWP-RedCap.
      else:
         switch the active DL BWP to BWP indicated by initialDownlinkBWP.
else:
   if the Serving Cell is an SpCell:
      if the active DL BWP does not have the same bwp-Id as the active UL BWP:
         switch the active DL BWP to the DL BWP with the same bwp-Id as the active UL BWP.
stop the bwp-InactivityTimer associated with the active DL BWP of this Serving Cell, if running.
if the Serving Cell is SCell:
   stop the bwp-InactivityTimer associated with the active DL BWP of SpCell, if running.
perform the Random Access procedure on the active DL BWP of SpCell and active UL BWP of this Serving Cell.

If the UE receives a PDCCH for BWP switching of a Serving Cell, the UE shall:
if there is no ongoing Random Access procedure associated with this Serving Cell; or
if the ongoing Random Access procedure associated with this Serving Cell is successfully completed upon reception of this PDCCH addressed to C-RNTI:
   cancel, if any, triggered consistent LBT failure for this Serving Cell;
   perform BWP switching to a BWP indicated by the PDCCH.

If the UE receives a PDCCH for BWP switching for a Serving Cell(s) or a dormancy SCell group(s) while a Random Access procedure associated with that Serving Cell is ongoing in the UE, it is up to UE implementation whether to switch BWP or ignore the PDCCH for BWP switching, except for the PDCCH reception for BWP switching addressed to the C-RNTI for successful Random Access procedure completion in which case the UE shall perform BWP switching to a BWP indicated by the PDCCH. Upon reception of the PDCCH for BWP switching other than successful contention resolution, if the UE decides to perform BWP switching, the UE shall stop the ongoing Random Access procedure and initiate a Random Access procedure after performing the BWP switching; if the MAC decides to ignore the PDCCH for BWP switching, the UE shall continue with the ongoing Random Access procedure on the Serving Cell.

Upon reception of RRC (re-)configuration for BWP switching for a Serving Cell while a Random Access procedure associated with that Serving Cell is ongoing in the UE, the UE shall stop the ongoing Random Access procedure and initiate a Random Access procedure after performing the BWP switching.

Upon reception of RRC (re-)configuration for BWP switching for a Serving Cell, cancel any triggered consistent LBT failure in this Serving Cell.

The UE shall for each activated Serving Cell configured with bwp-InactivityTimer:
if the defaultDownlinkBWP-Id is configured, and the active DL BWP is not the BWP indicated by the defaultDownlinkBWP-Id, and the active DL BWP is not the BWP indicated by the dormantBWP-Id if configured; or
if the UE is not a RedCap UE, and if the defaultDownlinkBWP-Id is not configured, and the active DL BWP is not the initialDownlinkBWP, and the active DL BWP is not the BWP indicated by the dormantBWP-Id if configured; or
if the UE is a RedCap UE, and if the defaultDownlinkBWP-Id is not configured, and initialDownlinkBWP-RedCap is not configured, and the active DL BWP is not the initialDownlinkBWP; or
if the UE is a RedCap UE, and if the defaultDownlinkBWP-Id is not configured, and initialDownlinkBWP-RedCap is configured, and the active DL BWP is not the initialDownlinkBWP-RedCap:
   if a PDCCH addressed to C-RNTI or CS-RNTI indicating downlink assignment or uplink grant is received on the active BWP; or
   if a PDCCH addressed to G-RNTI or G-CS-RNTI configured for multicast indicating downlink assignment is received on the active BWP; or
   if a PDCCH addressed to C-RNTI or CS-RNTI indicating downlink assignment or uplink grant is received for the active BWP; or
   if a MAC PDU is transmitted in a configured uplink grant and LBT failure indication is not received from lower layers; or
   if a MAC PDU is received in a configured downlink assignment for unicast or MBS multicast:
      if there is no ongoing Random Access procedure associated with this Serving Cell; or
      if the ongoing Random Access procedure associated with this Serving Cell is successfully completed upon reception of this PDCCH addressed to C-RNTI:
         start or restart the bwp-InactivityTimer associated with the active DL BWP.
   if the bwp-InactivityTimer associated with the active DL BWP expires:
      if the defaultDownlinkBWP-Id is configured:
         perform BWP switching to a BWP indicated by the defaultDownlinkBWP-Id.
      else:
         if the UE is a RedCap UE; and
         if initialDownlinkBWP-RedCap is configured: 5>perform BWP switching to the initialDownlinkBWP-RedCap.
         else: 5> perform BWP switching to the initialDownlinkBWP.
if a PDCCH for BWP switching is received, and the UE switches the active DL BWP:
   if the defaultDownlinkBWP-Id is configured, and the UE switches to the DL BWP which is not indicated by the defaultDownlinkBWP-Id and is not indicated by the dormantBWP-Id if configured; or
   if the UE is not a RedCap UE, and if the defaultDownlinkBWP-Id is not configured, and the UE switches to the DL BWP which is not the initialDownlinkBWP and is not indicated by the dormantBWP-Id if configured; or
   if the UE is a RedCap UE, and if the defaultDownlinkBWP-Id is not configured, and initialDownlinkBWP-RedCap is not configured, and the UE switches to the DL BWP which is not the initialDownlinkBWP; or
   if the UE is a RedCap UE, and if the defaultDownlinkBWP-Id is not configured, and initialDownlinkBWP-RedCap is configured, and the UE switches to the DL BWP which is not the initialDownlinkBWP-RedCap:
      start or restart the bwp-InactivityTimer associated with the active DL BWP.

Upon initiation of the Random Access procedure, after selection of the carrier for performing Random Access procedure if the UE is a RedCap UE in RRC_IDLE or RRC_INACTIVE mode, the UE shall:
if initialUplinkBWP-RedCap is configured for the selected carrier:
   perform the Random Access procedure by using the BWP configured by initialUplinkBWP-RedCap.
else:
   perform the Random Access procedure by using the BWP configured by initialUplinkBWP.
if initialDownlinkBWP-RedCap is configured:
   if the Random Access procedure was initiated for SI request and the Random Access Resources for SI request have been explicitly provided by RRC, and if the selected carrier is SUL carrier:
      monitor the PDCCH on the BWP configured by initialDownlinkBWP.
   else:
      monitor the PDCCH on the BWP configured by initialDownlinkBWP-RedCap.
else:
   monitor the PDCCH on the BWP configured by initialDownlinkBWP.

If the MAC entity is configured with one or more SCells, the network may activate and deactivate the configured SCells. Upon configuration of an SCell, the SCell is deactivated unless the parameter sCellState is set to activated for the SCell by upper layers.

The configured SCell(s) is activated and deactivated by:
receiving the SCell Activation/Deactivation MAC CE;
configuring sCellDeactivationTimer timer per configured SCell (except the SCell configured with PUCCH, if any): the associated SCell is deactivated upon its expiry;
configuring sCellState per configured SCell: if configured, the associated SCell is activated upon SCell configuration;
receiving scg-State: the SCells of SCG are deactivated.

The MAC entity shall for each configured SCell:
if an SCell is configured with sCellState set to activated upon SCell configuration, or an SCell Activation/Deactivation MAC CE or an Enhanced SCell Activation/Deactivation MAC CE is received activating the SCell:
   if the SCell was deactivated prior to receiving this Enhanced SCell Activation/Deactivation MAC CE and a TRS is indicated for this SCell:
      indicate to lower layers the information regarding the TRS.
   if the SCell was deactivated prior to receiving this SCell Activation/Deactivation MAC CE or this Enhanced SCell Activation/Deactivation MAC CE; or
   if the SCell is configured with sCellState set to activated upon SCell configuration:
      if firstActiveDownlinkBWP-Id is not set to dormant BWP:
         activate the SCell according to the timing for MAC CE activation and according to the timing for direct SCell activation; i.e. apply normal SCell operation including:
         SRS transmissions on the SCell;
         CSI reporting for the SCell;
         PDCCH monitoring on the SCell;
         PDCCH monitoring for the SCell;
         PUCCH transmissions on the SCell, if configured.
      else (i.e. firstActiveDownlinkBWP-Id is set to dormant BWP):
         stop the bwp-InactivityTimer of this Serving Cell, if running.
      activate the DL BWP and UL BWP indicated by firstActiveDownlinkBWP-Id and firstActiveUplinkBWP-Id respectively.
   start or restart the sCellDeactivationTimer associated with the SCell according to the timing for MAC CE activation and according to the timing for direct SCell activation;
   if the active DL BWP is not the dormant BWP:
      (re-)initialize any suspended configured uplink grants of configured grant Type 1 associated with this SCell according to the stored configuration, if any, and to start in the symbol according to rules;
      trigger PHR.
else if an SCell Activation/Deactivation MAC CE or an Enhanced SCell Activation/Deactivation MAC CE is received deactivating the SCell; or
if the sCellDeactivationTimer associated with the activated SCell expires; or
if the SCG associated with the activated SCell is deactivated:
   deactivate the SCell according to the timing;
   stop the sCellDeactivationTimer associated with the SCell;
   stop the bwp-InactivityTimer associated with the SCell;
   deactivate any active BWP associated with the SCell;
   clear any configured downlink assignment and any configured uplink grant Type 2 associated with the SCell respectively;
   clear any PUSCH resource for semi-persistent CSI reporting associated with the SCell;
   suspend any configured uplink grant Type 1 associated with the SCell;
   flush all HARQ buffers associated with the SCell;
   cancel, if any, triggered consistent LBT failure for the SCell.
if PDCCH on the activated SCell indicates an uplink grant or downlink assignment; or
if PDCCH on the Serving Cell scheduling the activated SCell indicates an uplink grant or a downlink assignment for the activated SCell; or
if a MAC PDU is transmitted in a configured uplink grant and LBT failure indication is not received from lower layers; or
if a MAC PDU is received in a configured downlink assignment:
   restart the sCellDeactivationTimer associated with the SCell.
if the SCell is deactivated:
   not transmit SRS on the SCell;
   not report CSI for the SCell;
   not transmit on UL-SCH on the SCell;
   not transmit on RACH on the SCell;
   not monitor the PDCCH on the SCell;
   not monitor the PDCCH for the SCell;
   not transmit PUCCH on the SCell.

HARQ feedback for the MAC PDU containing SCell Activation/Deactivation MAC CE or Enhanced SCell Activation/Deactivation MAC CE shall not be impacted by PCell, PSCell and PUCCH SCell interruptions due to SCell activation/deactivation

When SCell is deactivated, the ongoing Random Access procedure on the SCell, if any, is aborted.

The SCell Activation/Deactivation MAC CE of one octet is identified by a MAC subheader with LCID. It has a fixed size and consists of a single octet containing seven C-fields and one R-field. The SCell Activation/Deactivation MAC CE with one octet is defined.

The SCell Activation/Deactivation MAC CE of four octets is identified by a MAC subheader with LCID. It has a fixed size and consists of four octets containing 31 C-fields and one R-field. The SCell Activation/Deactivation MAC CE of four octets is defined as follows
Cᵢ: If there is an SCell configured for the MAC entity with SCellIndex i this field indicates the activation/deactivation status of the SCell with SCellIndex i, else the MAC entity shall ignore the Cᵢ field. The Cᵢ field is set to 1 to indicate that the SCell with SCellIndex i shall be activated. The Cᵢ field is set to 0 to indicate that the SCell with SCellIndex i shall be deactivated;
R: Reserved bit, set to 0.

The MAC entity may be configured by RRC per Serving Cell or per BFD-RS set with a beam failure recovery procedure which is used for indicating to the serving gNB of a new SSB or CSI-RS when beam failure is detected on the serving SSB(s)/CSI-RS(s). Beam failure is detected by counting beam failure instance indication from the lower layers to the MAC entity. If beamFailureRecoveryConfig is reconfigured by upper layers during an ongoing Random Access procedure for beam failure recovery for SpCell, the MAC entity shall stop the ongoing Random Access procedure and initiate a Random Access procedure using the new configuration. The Serving Cell is configured with two BFD-RS sets if and only if failureDetectionSet1 and failureDetectionSet2 are configured for the active DL BWP of the Serving Cell. When the SCG is deactivated, the UE performs beam failure detection on the PSCell if bfd-and-RLM is set to true.

RRC configures the following parameters in the beamFailureRecoveryConfig, beamFailureRecoverySpCellConfig, beamFailureRecoverySCellConfig and the radioLinkMonitoringConfig for the Beam Failure Detection and Recovery procedure:
beamFailurelnstanceMaxCount for the beam failure detection (per Serving Cell or per BFD-RS set of Serving Cell configured with two BFD-RS sets);
beamFailureDetectionTimer for the beam failure detection (per Serving Cell or per BFD-RS set of Serving Cell configured with two BFD-RS sets);
beamFailureRecoveryTimer for the beam failure recovery procedure for SpCell;
rsrp-ThresholdSSB: an RSRP threshold for the SpCell beam failure recovery;
rsrp-ThresholdBFR: an RSRP threshold for the SCell beam failure recovery or for the beam failure recovery of BFD-RS set of Serving Cell;
powerRampingStep: powerRampingStep for the SpCell beam failure recovery;
powerRampingStepHighPriority: powerRampingStepHighPriority for the SpCell beam failure recovery;
preambleReceivedTargetPower: preambleReceivedTargetPower for the SpCell beam failure recovery;
preambleTransMax: preambleTransMax for the SpCell beam failure recovery;
scalingFactorBI: scalingFactorBI for the SpCell beam failure recovery;
ssb-perRACH-Occasion: ssb-perRACH-Occasion for the SpCell beam failure recovery using contention-free Random Access Resources;
ra-ResponseWindow: the time window to monitor response(s) for the SpCell beam failure recovery using contention-free Random Access Resources;
prach-ConfigurationIndex: prach-ConfigurationIndex for the SpCell beam failure recovery using contention-free Random Access Resources;
ra-ssb-OccasionMaskIndex: ra-ssb-OccasionMaskIndex for the SpCell beam failure recovery using contention-free Random Access Resources;
ra-OccasionList: ra-OccasionList for the SpCell beam failure recovery using contention-free Random Access Resources;
candidateBeamRSList: list of candidate beams for SpCell beam failure recovery;
candidateBeamRS-List-r16: list of candidate beams for SCell beam failure recovery or list of candidate beams for beam failure recovery of a Serving Cell for BFD-RS set one;
candidateBeamRS-List2-r17: list of candidate beams for beam failure recovery of a Serving Cell for BFD-RS set two.

The following UE variables are used for the beam failure detection procedure:
BFI_COUNTER (per Serving Cell or per BFD-RS set of Serving Cell configured with two BFD-RS sets): counter for beam failure instance indication which is initially set to 0.

The MAC entity shall for each Serving Cell configured for beam failure detection:
if the Serving Cell is configured with two BFD-RS sets:
   if beam failure instance indication for a BFD-RS set has been received from lower layers:
      start or restart the beamFailureDetectionTimer of the BFD-RS set;
      increment BFI_COUNTER of the BFD-RS set by 1;
      if BFI_COUNTER of the BFD-RS set>=beamFailurelnstanceMaxCount:
         trigger a BFR for this BFD-RS set of the Serving Cell;
   if BFR is triggered for both BFD-RS sets of the SpCell and the Beam Failure Recovery procedure is not successfully completed for any of the BFD-RS sets:
      initiate a Random Access procedure on the SpCell;
   if the Serving Cell is SpCell and the Random Access procedure initiated for beam failure recovery of both BFD-RS sets of SpCell is successfully completed:
      set BFI_COUNTER of each BFD-RS set of SpCell to 0.
      consider the Beam Failure Recovery procedure successfully completed.
   if the beamFailureDetectionTimer of this BFD-RS set expires; or
   if beamFailureDetectionTimer, beamFailurelnstanceMaxCount, or any of the reference signals used for beam failure detection is reconfigured by upper layers or by the BFD-RS Indication MAC CE associated with a BFD-RS set of the Serving Cell; or
   if the reference signal(s) associated with a BFD-RS set of the Serving Cell used for beam failure detection is changed:
      set BFI_COUNTER of the BFD-RS set to 0.
   if a PDCCH addressed to C-RNTI indicating uplink grant for a new transmission is received for the HARQ process used for the transmission of the Enhanced BFR MAC CE or Truncated Enhanced BFR MAC CE which contains beam failure recovery information of this BFD-RS set of the Serving Cell:
      set BFI_COUNTER of the BFD-RS set to 0;
      consider the Beam Failure Recovery procedure successfully completed for this BFD-RS set and cancel all the triggered BFRs of this BFD-RS set of the Serving Cell.
   if the Serving Cell is SCell and the SCell is deactivated clause 5.9:
      set BFI_COUNTER of each BFD-RS set of SCell to 0;
      consider the Beam Failure Recovery procedure successfully completed and cancel all the triggered BFRs of all BFD-RS sets of the Serving Cell.
else:
   if beam failure instance indication has been received from lower layers:
      start or restart the beamFailureDetectionTimer;
      increment BFI_COUNTER by 1;
      if BFI_COUNTER>=beamFailurelnstanceMaxCount:
         if the Serving Cell is SCell:
         trigger a BFR for this Serving Cell;
         else if the Serving Cell is PSCell and, the SCG is deactivated:
         if beam failure of the PSCell has not been indicated to upper layers since the SCG was deactivated or since the deactivated SCG was last reconfigured with BFD-RS:
         indicate beam failure of the PSCell to upper layers.
         else:
         initiate a Random Access procedure on the SpCell;
         if beam failure is detected for an NCR-MT:
         indicate to NCR-Fwd to cease forwarding.
   if the beamFailureDetectionTimer expires; or
   if beamFailureDetectionTimer, beamFailurelnstanceMaxCount, or any of the reference signals used for beam failure detection is reconfigured by upper layers associated with this Serving Cell; or
   if the reference signal(s) associated with this Serving Cell used for beam failure detection is changed:
      set BFI_COUNTER to 0.
   if the Serving Cell is SpCell and the Random Access procedure initiated for SpCell beam failure recovery is successfully completed:
      set BFI_COUNTER to 0;
      stop the beamFailureRecoveryTimer, if configured;
      if the Random Access procedure was triggered by beam failure recovery for NCR-MT:
         indicate to NCR-Fwd to resume forwarding using the last forwarding configuration received by NCR-MT as part of side control information before beam failure detection;
      consider the Beam Failure Recovery procedure successfully completed.
   else if the Serving Cell is SCell, and a PDCCH addressed to C-RNTI indicating uplink grant for a new transmission is received for the HARQ process used for the transmission of the MAC CE for BFR which contains beam failure recovery information of this Serving Cell; or
   if the SCell is deactivated as specified:
      set BFI_COUNTER to 0;
      consider the Beam Failure Recovery procedure successfully completed and cancel all the triggered BFRs for this Serving Cell.

The MAC entity shall:
if the Beam Failure Recovery procedure determines that at least one BFR has been triggered and not cancelled for an SCell for which evaluation of the candidate beams according to the requirements has been completed and if none of the Serving Cell(s) of this MAC entity are configured with two BFD-RS sets:
   if UL-SCH resources are available for a new transmission and if the UL-SCH resources can accommodate the BFR MAC CE plus its subheader as a result of LCP:
      instruct the Multiplexing and Assembly procedure to generate the BFR MAC CE.
   else if UL-SCH resources are available for a new transmission and if the UL-SCH resources can accommodate the Truncated BFR MAC CE plus its subheader as a result of LCP:
      instruct the Multiplexing and Assembly procedure to generate the Truncated BFR MAC CE.
   else:
      trigger the SR for SCell beam failure recovery for each SCell for which BFR has been triggered, not cancelled, and for which evaluation of the candidate beams according to the requirements has been completed.
if the Beam Failure Recovery procedure determines that at least one BFR for any BFD-RS set has been triggered and not cancelled for an SCell for which evaluation of the candidate beams according to the requirements has been completed; or
if the Beam Failure Recovery procedure determines that at least one BFR for only one BFD-RS set has been triggered and not cancelled for an SpCell for which evaluation of the candidate beams according to the requirements has been completed; or
if the Beam Failure Recovery procedure determines that at least one BFR has been triggered and not cancelled for an SCell for which evaluation of the candidate beams according to the requirements has been completed and if at least one Serving Cell of this MAC entity is configured with two BFD-RS sets:
   if UL-SCH resources are available for a new transmission and if the UL-SCH resources can accommodate the Enhanced BFR MAC CE plus its subheader as a result of LCP:
      instruct the Multiplexing and Assembly procedure to generate the Enhanced BFR MAC CE.
   else if UL-SCH resources are available for a new transmission and if the UL-SCH resources can accommodate the Truncated Enhanced BFR MAC CE plus its subheader as a result of LCP:
      instruct the Multiplexing and Assembly procedure to generate the Truncated Enhanced BFR MAC CE.
   else:
      trigger the SR for beam failure recovery of each BFD-RS set for which BFR has been triggered, not cancelled, and for which evaluation of the candidate beams according to the requirements has been completed;
      trigger the SR for SCell beam failure recovery for each SCell for which BFR has been triggered, not cancelled, and for which evaluation of the candidate beams according to the requirements has been completed.

All BFRs triggered for an SCell shall be cancelled when a MAC PDU is transmitted and this PDU includes a MAC CE for BFR which contains beam failure information of that SCell. All BFRs triggered for a BFD-RS set of a Serving Cell shall be cancelled when a MAC PDU is transmitted and this PDU includes an Enhanced BFR MAC CE or Truncated Enhanced BFR MAC CE which contains beam failure recovery information of that BFD-RS set of the Serving Cell.

When the RSRP of beam (e.g. SSB or CSI-RS) falls below a certain threshold for a certain time duration, it's considered a beam failure is detected.
BFR MAC CE

The MAC CEs for BFR consists of either:
BFR MAC CE; or
Truncated BFR MAC CE.

The BFR MAC CE and Truncated BFR MAC CE are identified by a MAC subheader with LCID/eLCID Table 6.2.1-2 and Table 6.2.1-2b.

The BFR MAC CE and Truncated BFR MAC CE have a variable size. They include a bitmap and in ascending order based on the ServCellIndex, beam failure recovery information i.e. octets containing candidate beam availability indication (AC) for SCells indicated in the bitmap. For BFR MAC CE, a single octet bitmap is used when the highest ServCellIndex of this MAC entity's SCell for which beam failure is detected and the evaluation of the candidate beams according to the requirements has been completed is less than 8, otherwise four octets are used. A MAC PDU shall contain at most one BFR MAC CE.

For Truncated BFR MAC CE, a single octet bitmap is used for the following cases, otherwise four octets are used:
the highest ServCellIndex of this MAC entity's SCell for which beam failure is detected and the evaluation of the candidate beams according to the requirements has been completed is less than 8; or
beam failure is detected for SpCell and the SpCell is to be indicated in a Truncated BFR MAC CE and the UL-SCH resources available for transmission cannot accommodate the Truncated BFR MAC CE with the four octets bitmap plus its subheader as a result of LCP.

The fields in the BFR MAC CEs are defined as follows:
SP: This field indicates beam failure detection for the SpCell of this MAC entity.

The SP field is set to 1 to indicate that beam failure is detected for SpCell only when BFR MAC CE or Truncated BFR MAC CE is to be included into a MAC PDU as part of Random Access Procedure (as specified in 5.1.3a and 5.1.4), otherwise, it is set to 0;
Cᵢ(BFR MAC CE): This field indicates beam failure detection and the presence of an octet containing the AC field for the SCell with ServCellIndex i. The Cᵢ field set to 1 indicates that beam failure is detected, the evaluation of the candidate beams according to the requirements has been completed, and the octet containing the AC field is present for the SCell with ServCellIndex i. The Cᵢ field set to 0 indicates that the beam failure is either not detected or the beam failure is detected but the evaluation of the candidate beams according to the requirements has not been completed, and the octet containing the AC field is not present for the SCell with ServCellIndex i. The octets containing the AC field are present in ascending order based on the ServCellIndex;
Cᵢ (Truncated BFR MAC CE): This field indicates beam failure detection for the SCell with ServCellIndex i. The Cᵢ field set to 1 indicates that beam failure is detected, the evaluation of the candidate beams according to the requirements has been completed, and the octet containing the AC field for the SCell with ServCellIndex i may be present. The Cᵢ field set to 0 indicates that the beam failure is either not detected or the beam failure is detected but the evaluation of the candidate beams according to the requirements has not been completed, and the octet containing the AC field is not present for the SCell with ServCellIndex i. The octets containing the AC field, if present, are included in ascending order based on the ServCellIndex. The number of octets containing the AC field included is maximised, while not exceeding the available grant size;
AC: This field indicates the presence of the Candidate RS ID field in this octet. If at least one of the SSBs with SS-RSRP above rsrp-ThresholdBFR amongst the SSBs in candidateBeamRSSCellList or the CSI-RSs with CSI-RSRP above rsrp-ThresholdBFR amongst the CSI-RSs in candidateBeamRSSCellList is available, the AC field is set to 1; otherwise, it is set to 0. If the AC field set to 1, the Candidate RS ID field is present. If the AC field set to 0, R bits are present instead;
Candidate RS ID: This field is set to the index of an SSB with SS-RSRP above rsrp-ThresholdBFR amongst the SSBs in candidateBeamRSSCellList or to the index of a CSI-RS with CSI-RSRP above rsrp-ThresholdBFR amongst the CSI-RSs in candidateBeamRSSCellList. Index of an SSB or CSI-RS is the index of an entry in candidateBeamRSSCellList corresponding to the SSB or CSI-RS. Index 0 corresponds to the first entry in the candidateBeamRSSCellList, index 1 corresponds to the second entry in the list and so on. The length of this field is 6 bits.
R: Reserved bit, set to 0.

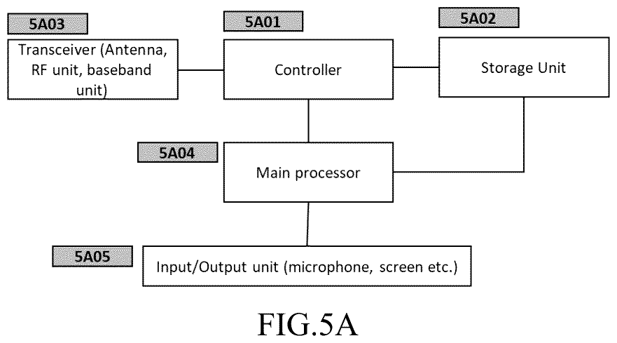

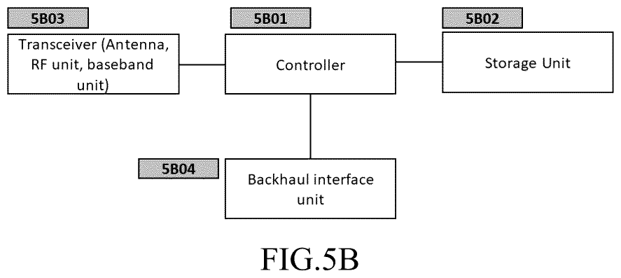

FIG. 5A is a block diagram illustrating the internal structure of a Terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mil0r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

FIG. 5B is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in FIG. 2A are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to deter mine whether to provide the terminal with multi-connection or to discontinue the same. In addition, the storage unit (5B02) provides stored data at a request of the controller (5B01).

The transceiver (5B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mil0r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | |
|---|---|
| 5GC | 5G Core Network |
| ACK | Acknowledgement |
| AM | Acknowledged Mode |
| AMF | Access and Mobility Management Function |
| ARQ | Automatic Repeat Request |
| AS | Access Stratum |
| ASN.1 | Abstract Syntax Notation One |
| BSR | Buffer Status Report |
| BWP | Bandwidth Part |
| CA | Carrier Aggregation |
| CAG | Closed Access Group |
| CG | Cell Group |
| C-RNTI | Cell RNTI |
| CSI | Channel State Information |
| DCI | Downlink Control Information |
| DRB | (user) Data Radio Bearer |
| DTX | Discontinuous Reception |
| HARQ | Hybrid Automatic Repeat Request |
| IE | Information element |
| LCG | Logical Channel Group |
| MAC | Medium Access Control |
| MIB | Master Information Block |
| NAS | Non-Access Stratum |
| NG-RAN | NG Radio Access Network |
| NR | NR Radio Access |
| PBR | Prioritised Bit Rate |
| PCell | Primary Cell |
| PCI | Physical Cell Identifier |
| PDCCH | Physical Downlink Control Channel |
| PDCP | Packet Data Convergence Protocol |
| PDSCH | Physical Downlink Shared Channel |
| PDU | Protocol Data Unit |
| PHR | Power Headroom Report |
| PLMN | Public Land Mobile Network |
| PRACH | Physical Random Access Channel |
| CRP | Cell Reselection Priority |
| PRB | Physical Resource Block |
| PSS | Primary Synchronisation Signal |
| PUCCH | Physical Uplink Control Channel |
| PUSCH | Physical Uplink Shared Channel |
| RACH | Random Access Channel |
| RAN | Radio Access Network |
| RAR | Random Access Response |
| RA-RNTI | Random Access RNTI |
| RAT | Radio Access Technology |
| RB | Radio Bearer |
| RLC | Radio Link Control |
| RNA | RAN-based Notification Area |
| RNAU | RAN-based Notification Area Update |
| RNTI | Radio Network Temporary Identifier |
| RRC | Radio Resource Control |
| RRM | Radio Resource Management |
| RSRP | Reference Signal Received Power |
| RSRQ | Reference Signal Received Quality |
| RSSI | Received Signal Strength Indicator |
| SCell | Secondary Cell |
| SCS | Subcarrier Spacing |
| SDAP | Service Data Adaptation Protocol |
| SDU | Service Data Unit |
| SFN | System Frame Number |
| S-GW | Serving Gateway |
| SI | System Information |
| SIB | System Information Block |
| SpCell | Special Cell |
| SRB | Signalling Radio Bearer |
| SRS | Sounding Reference Signal |
| SS | Search Space |
| SSB | SS/PBCH block |
| SSS | Secondary Synchronisation Signal |
| SUL | Supplementary Uplink |
| TM | Transparent Mode |
| UCI | Uplink Control Information |
| UE | User Equipment |
| UM | Unacknowledged Mode |

What is claimed is:

1. A method performed by a terminal, the method comprising:
receiving from a base station a radio resource control (RRC) message, wherein the RRC message comprises a set of configuration parameters for a secondary cell (SCell);
receiving from the base station a set of bits in a downlink message, wherein:
a specific bit of the set of bits is set to a first value; and
the specific bit corresponds to the SCell;
setting a beam failure counter of the SCell to a specific value;
cancelling a beam failure recovery triggered for the SCell;
stopping a layer 1 measurement reporting for the SCell; and
removing the SCell from a list for layer 3 measurement.

2. The method of claim 1, wherein:
the beam failure counter of the SCell increments by one in case that beam failure is detected for the SCell;
the beam failure recovery is triggered in case that the beam failure counter is equal to a maximum count; and
the maximum count is indicated in the set of configuration parameters for the SCell.

3. The method of claim 2, wherein:
the beam failure counter of the SCell changes to the specific value in case that a specific timer expires or the downlink message with the specific bit set to the first value is received;
the specific timer starts in case that beam failure of the SCell is detected when the beam failure counter of the SCell is the specific value;
the specific timer restarts in case that beam failure of the SCell is detected when the beam failure counter of the SCell is greater than the specific value; and
an initial value of the specific timer is indicated in the set of configuration parameters for the SCell.

4. The method of claim 1,
wherein the list for layer 3 measurement comprises one or more physical cell identities.

5. The method of claim 4, wherein:
a physical cell identity of the SCell is included in the list for layer 3 measurement in case that entering condition is met for the SCell; and
a layer 3 measurement reporting is triggered in case that the physical cell identity of the SCell is included in the list for layer 3 measurement.

6. The method of claim 1, the method further comprising:
receiving from the base station a second set of bits in a second downlink message, wherein:
a second specific bit of the second set of bits is set to a second value; and
the second specific bit corresponds to the SCell;
starting the layer 1 measurement reporting for the SCell; and
triggering a layer 3 measurement reporting in case that the SCell is included in the list for layer 3 measurement.

7. The method of claim 6, wherein the second specific bit of the second set of bits in the second downlink message:
causes state transition of the SCell from a first state to a second state in case that the second specific bit is set to the first value; and
causes state transition of the SCell from the second state to the first state in case that the second specific bit is set to the second value.

8. The method of claim 7, wherein the set of bits in the downlink message:
causes state transition of the SCell from the first state to the second state in case that the specific bit of the set of bits in the downlink message is set to the first value; and
does not cause state transition of the SCell from the second state to the first state in case that the specific bit of the set of bits in the downlink message is set to the second value.

9. The method of claim 8, wherein:
position of the specific bit of the set of bits is determined based on a first parameter; and
position of the second specific bit of the second set of bits is determined based on a second parameter.

10. The method of claim 8, wherein, in case that the SCell is in the first state, the terminal:
does not transmit sounding reference signal (SRS) on the SCell;
does not report channel state information (CSI) for the SCell;
does not transmit uplink-shared channel (UL-SCH) on the SCell;
does not transmit random access channel (RACH) on the SCell;
does not monitor physical downlink control channel (PDCCH) on the SCell;
does not monitor PDCCH for the SCell; and
does not transmit physical uplink control channel (PUCCH) on the SCell.

11. The method of claim 10, wherein, in case that the SCell is in the second state, the terminal performs:
SRS transmissions on the SCell;
CSI reporting for the SCell;
PDCCH monitoring on the SCell;
PDCCH monitoring for the SCell; and
PUCCH transmissions on the SCell.

12. The method of claim 11,
wherein the layer 1 measurement reporting is performed on PUCCH.

13. The method of claim 2,
wherein the terminal generates a specific uplink control message in case that the beam failure recovery is triggered for the SCell.

14. The method of claim 13, wherein:
the specific uplink control message comprises a specific number of bits;
each bit of the specific number of bits corresponds to a serving cell; and
one or more candidate reference signal identifier fields.

15. A terminal in a wireless communication system, the terminal comprising:
a transceiver configured to transmit and receive a signal; and
a controller configured to control the transceiver to:
receive from a base station a radio resource control (RRC) message, wherein the RRC message comprises a set of configuration parameters for a secondary cell (SCell),
receive from the base station a set of bits in a downlink message, wherein:
a specific bit of the set of bits is set to a first value; and
the specific bit corresponds to the SCell,
set a beam failure counter of the SCell to a specific value,
cancel all triggered beam failure recoveries of the SCell,
stop a layer 1 measurement reporting for the SCell, and
remove the SCell from a list for layer 3 measurement.
